(19) United States
(12) Patent Application Publication
(10) Pub. No.: US 2005/0237159 A1
(43) Pub. Date: Oct. 27, 2005

(54) RFID tag systems, RFID tags and RFID processes with reverse link burst mode

(75) Inventors: Scott Anthony Cooper, Seattle, WA (US); Kurt Eugene Sundstrom, Woodinville, WA (US); Christopher J. Diorio, Shoreline, WA (US); Vincent C. Moretti, Kenmore, WA (US)

Correspondence Address: MERCHANT & GOULD PC, P.O. BOX 2903, MINNEAPOLIS, MN, 55402-0903, US

(73) Assignee: Impinj, Inc., Seattle, WA (US)

(21) Appl. No.: 11/084,460

(22) Filed: Mar. 17, 2005

Related U.S. Application Data
(60) Provisional application No. 60/562,095, filed on Apr. 13, 2004.

(51) Int. Cl. H04Q 5/22

(52) U.S. Cl. 340/10.5; 340/10.2

(57) ABSTRACT

A process is disclosed for exchanging data between one or more RFID tags and an interrogation unit comprising transmitting a burst of data from the one or more RFID tags.

### RELATED APPLICATIONS

This application claims the benefit of U.S. Provisional Application No. 60/562,095, filed on Apr. 13, 2004, entitled “RFID Tag Systems, RFID Tags and RFID Processes With Reverse Link Burst Mode”, listing Scott Cooper, Kurt Sundstrom and Chris Diorio as inventors, which is hereby incorporated herein by reference.

### TECHNICAL FIELD

This disclosure describes processes, apparatus and techniques applicable to RFID (radio frequency identification) tag technology. More particularly, this disclosure describes processes and apparatus for facilitating rapid communications between an interrogator and a population of RFID tags.

### BACKGROUND

RFID tagging systems have been developed to facilitate tracking of objects attached to tags, which, in turn, can be polled by an interrogator. Such systems are useful for inventory management and for location of tagged objects within a population of objects being monitored. RF tagging systems have been used to manage an ensemble of railroad cars distributed over a wide geographic range, to manage livestock, to track inventory in retail and shipping and for toll collections on toll roads, among other things.

However, conventional RFID tag systems employ signaling and communication algorithms having limited efficiency, in part because such protocols typically employ a transactional mode for communications from the RFID tag to the interrogation unit. These transactional modes use a serial exchange of brief messages, each including very few data bits or symbols, between the interrogator and one or more of the RFID tags. In other words, conventional communications protocols are such that every symbol transmitted from a RFID tag requires an accompanying symbol transmission by the interrogator. Additionally, passive RFID tag systems rely on energy derived from an incoming signal, and because the RFID tags have limited energy storage capacity, a premium is placed on efficiency of signaling protocols. Further, communication range is compromised.

Typically, an interrogation unit or reader identifies a specific RF tag in a population of tags by “singulation” of the specific tag. In such processes, the interrogation unit traverses a population of tags by engaging in a series of signal exchanges with progressively smaller portions of the tag population to identify or singulate one RFID tag in the population. The interrogation unit then verifies singulation of the specific RFID tag using an identification code unique to that RFID tag, such as a serial number, to provide acknowledgement of singulation. Data communications between the interrogation unit and only the identified RFID tag then are possible.

When RF tags are deployed to track a large population of items, the length of the identification code contributes to inefficiency in singulation. Additionally, overall economic concerns associated with system deployment and operation place a premium on reliability and efficiency of each RFID tag.

Accordingly, improved apparatus, processes and techniques are needed for efficiently singulating a population of RFID tags and effectuating data communications between one or more RFID tags and an associated tag interrogation unit.

### SUMMARY

Architectures and methodologies for organizing data exchanges between a reader and multiple tags are disclosed. In one aspect, a process for exchanging data between one or more RFID tags and an interrogation unit comprising transmitting a burst of data from the one or more RFID tags is disclosed.

### BRIEF DESCRIPTION OF THE CONTENTS

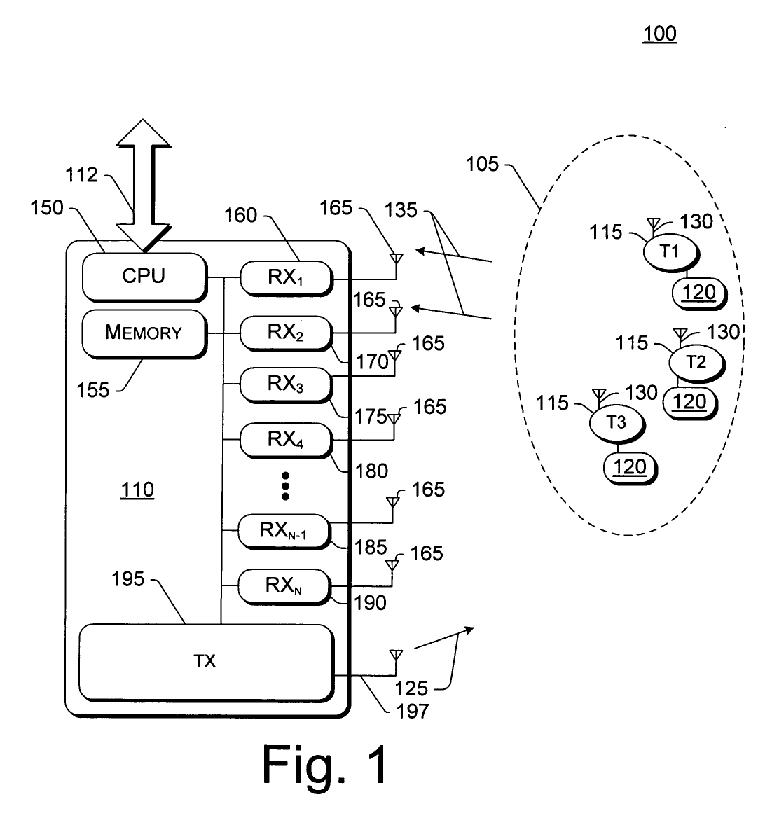

FIG. 1 is an exemplary block diagram of a system including an RFID tag population and an interrogation unit.

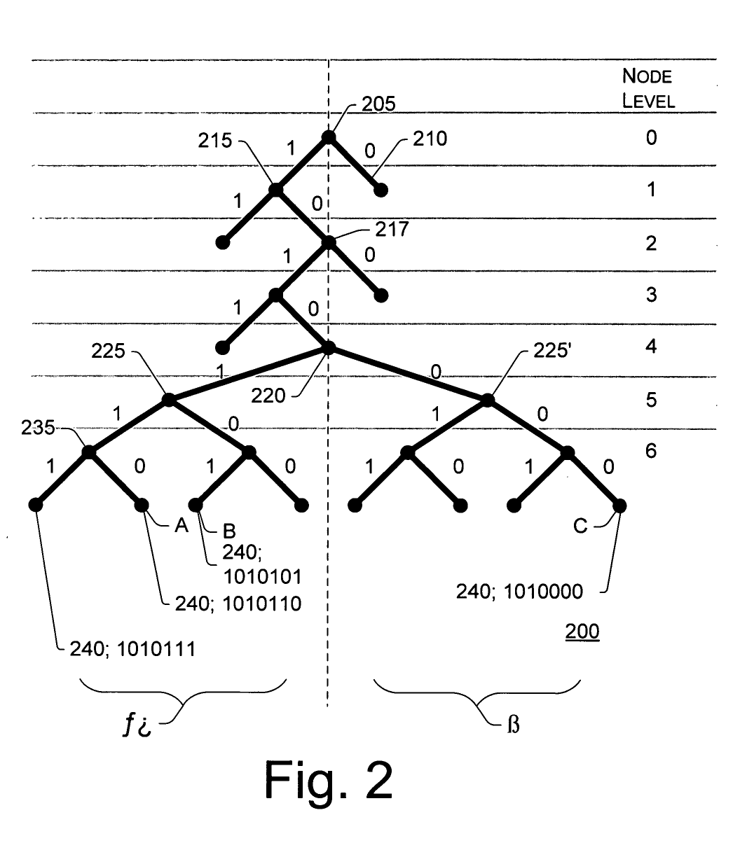

FIG. 2 is a schematic diagram showing an hierarchy of RFID tags, organized into a binary tree structure according to an exemplary seven bit serial number.

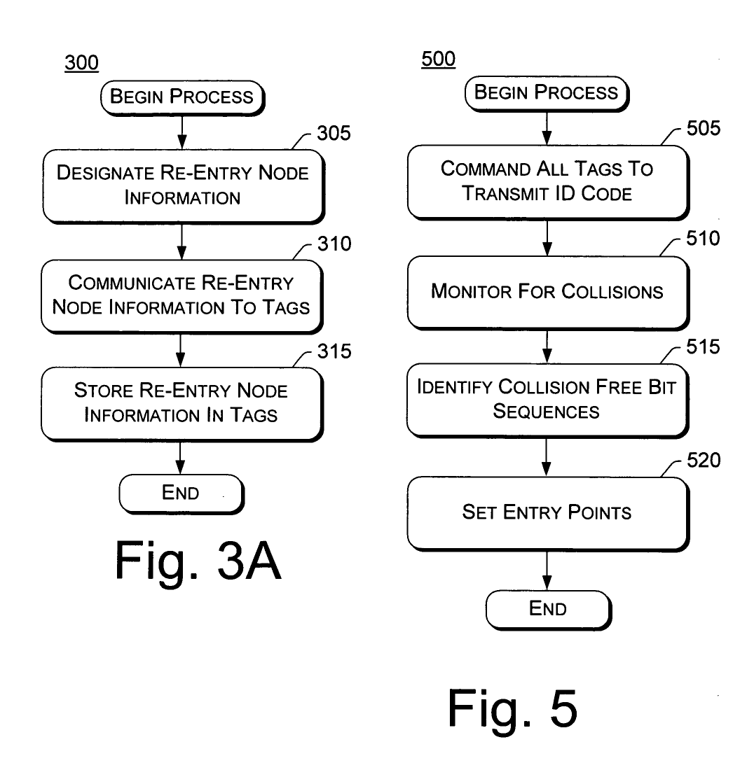

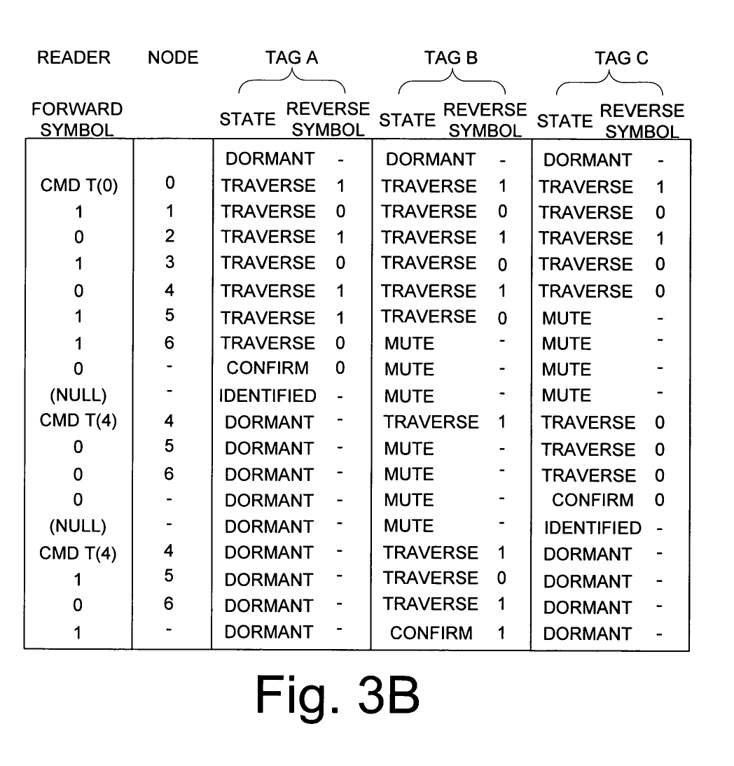

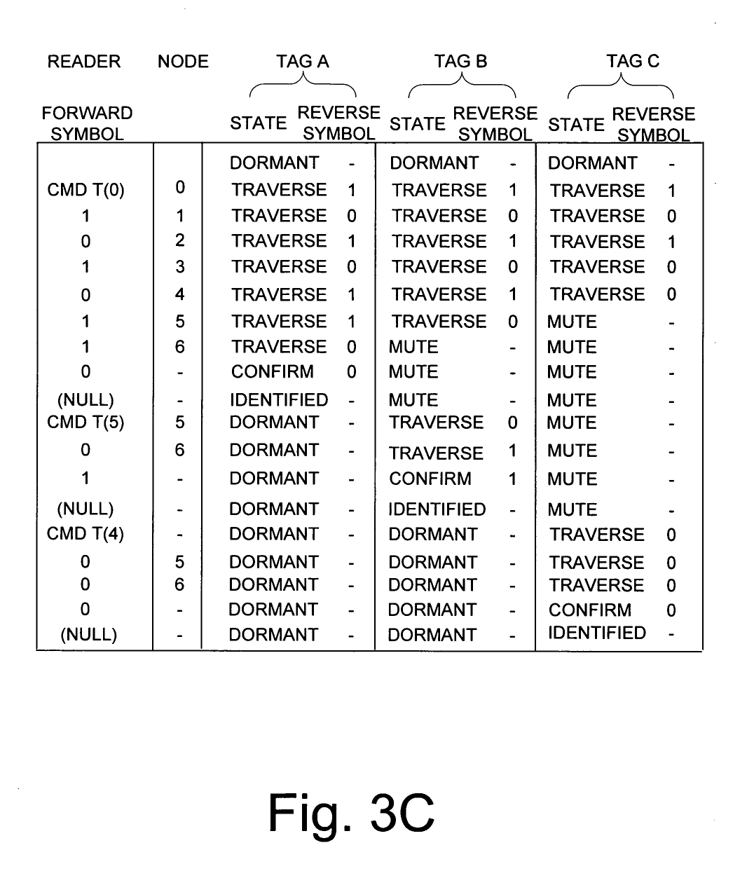

FIG. 3A is a flowchart describing a process for transmitting re-entry node information to a population of RFID tags.

FIG. 3B is a table describing a process for determining re-entry node information in an RFID tag system.

FIG. 3C is a table describing a process for determining re-entry node information in an RFID tag system.

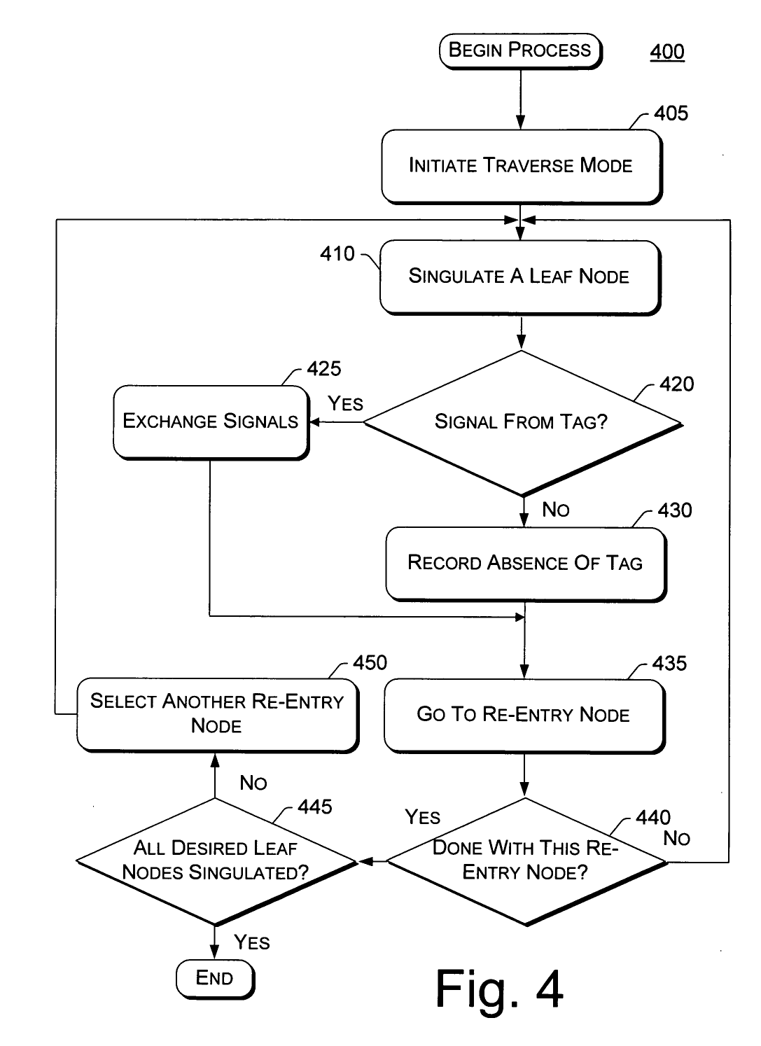

FIG. 4 is a flowchart describing a process for traversing a population of RFID tags.

FIG. 5 is a flowchart describing a process for determining common bit sequences in a population of RFID tags and for setting entry nodes in a binary tree mapping the RFID tag population.

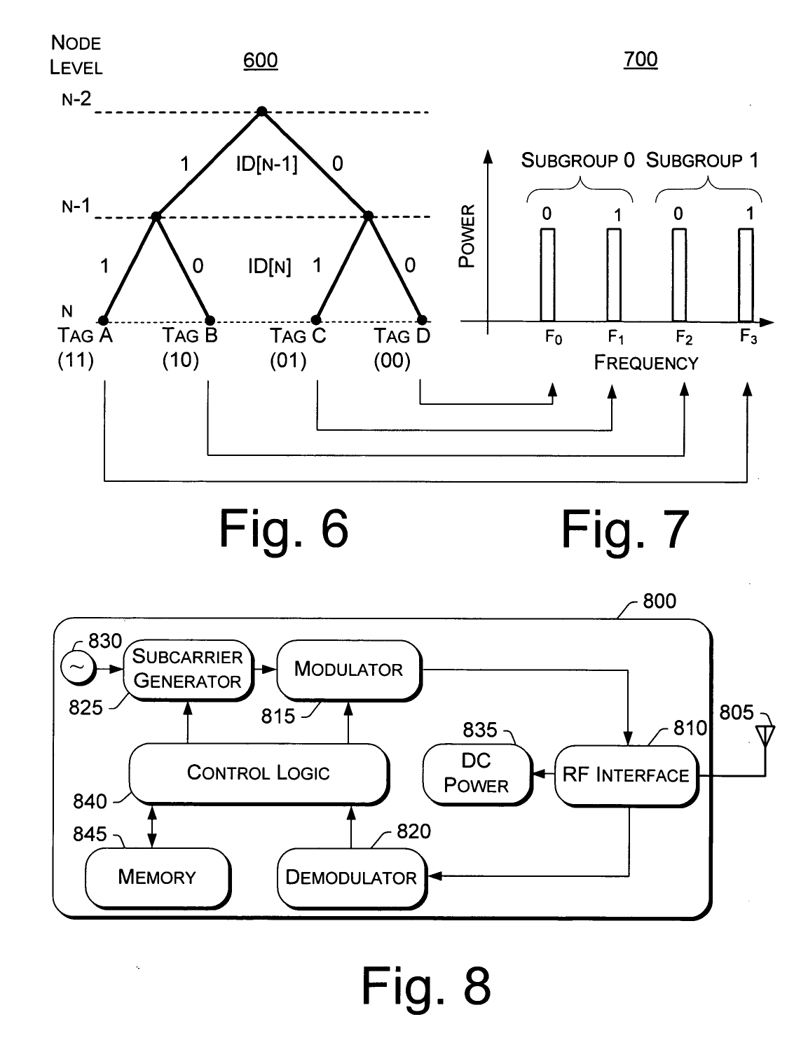

FIG. 6 represents a portion of a binary tree.

FIG. 7 is a graph of power versus frequency illustrating four subcarrier frequencies.

FIG. 8 is a block diagram of an exemplary RFID tag communications system that may be contained in each of the RFID tags of FIG. 1 and that is useful in the context of the subcarrier signaling arrangement of FIGS. 6 and 7.

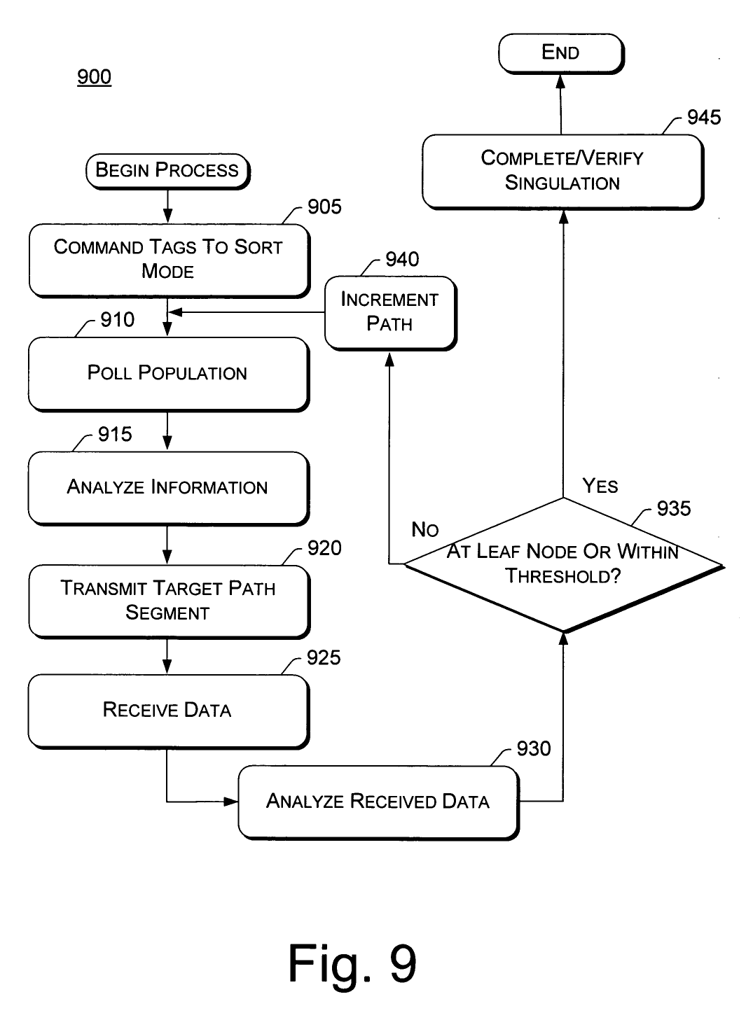

FIG. 9 is a flowchart describing an interrogation unit process for traversing a population of RFID tags that is useful in the context of the N-FSK signaling protocol described with reference to FIGS. 6, 7 and 8.

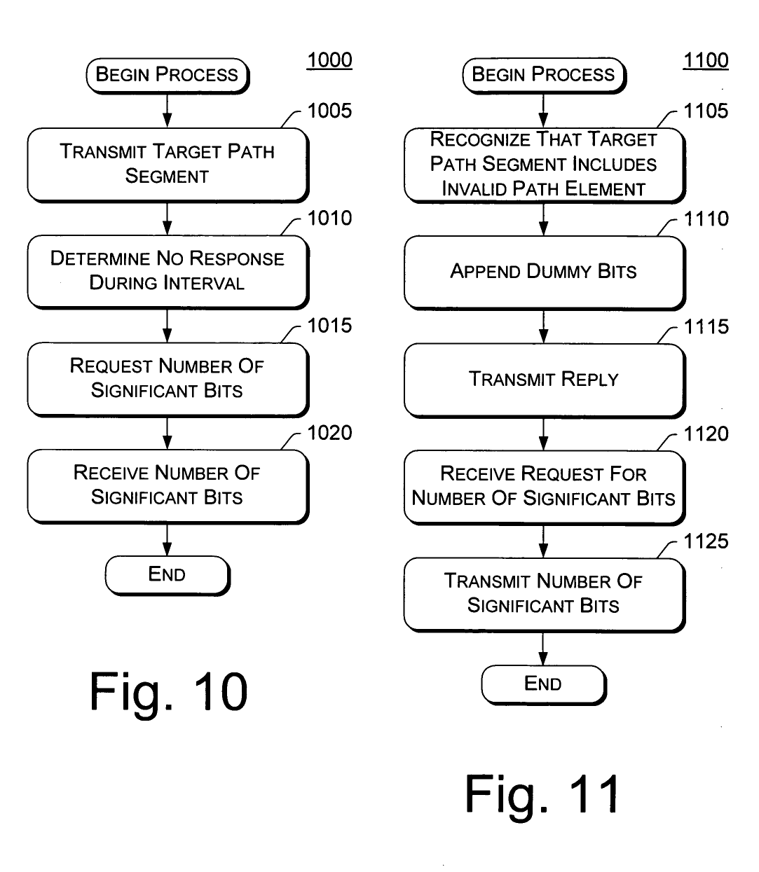

FIG. 10 is a flowchart illustrating an interrogation unit process for singulation and verification of a leaf node when the interrogation unit does not have knowledge of ID code length.

FIG. 11 is a flowchart illustrating an RFID tag process for singulation and verification of a leaf node when the interrogation unit does not have knowledge of ID code length.

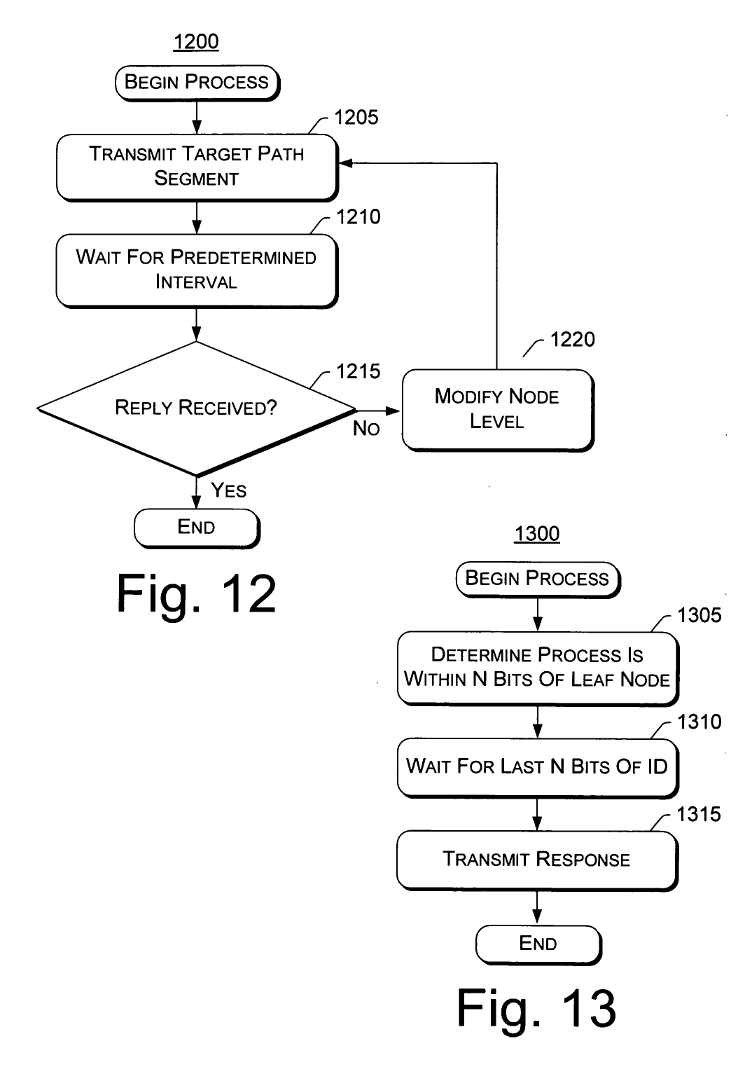

FIG. 12 is a flowchart illustrating an interrogation unit process for singulation and verification of a leaf node when the interrogation unit does not have knowledge of ID code length.

FIG. 13 is a flowchart illustrating an RFID tag process for singulation and verification of a leaf node when the interrogation unit does not have knowledge of ID code length.

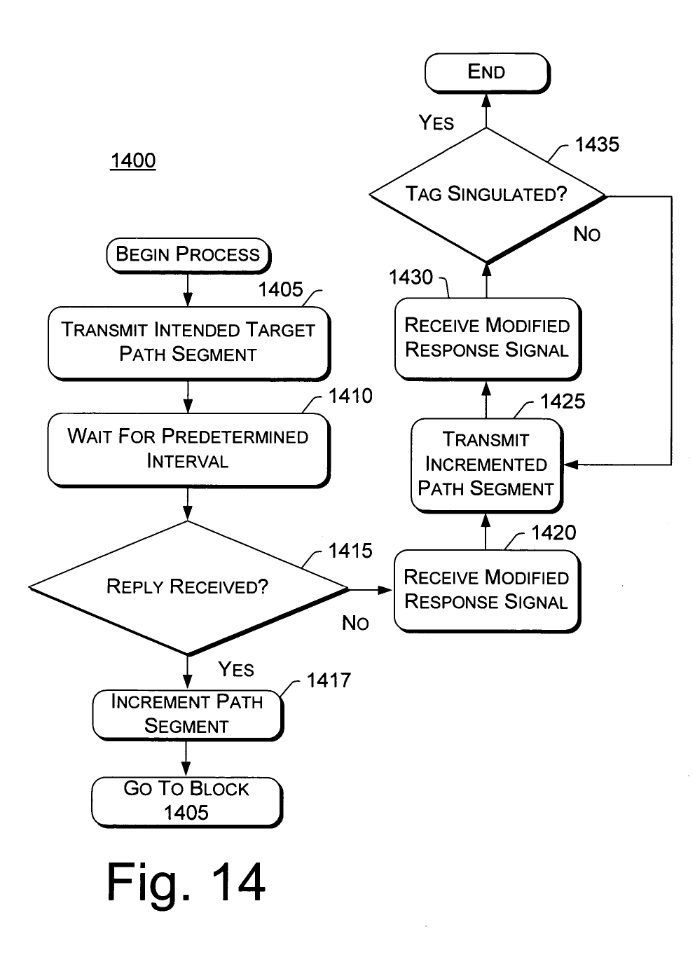

FIG. 14 is a flowchart illustrating an interrogation unit process for singulation and verification of a leaf node when the interrogation unit does not have knowledge of ID code length.

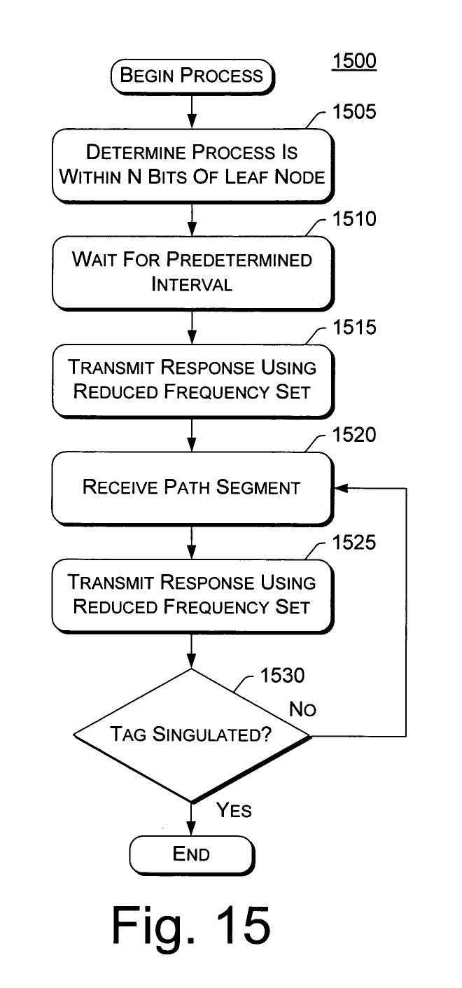

FIG. 15 is a flowchart illustrating an RFID tag process for singulation and verification of a leaf node when the interrogation unit does not have knowledge of ID code length.

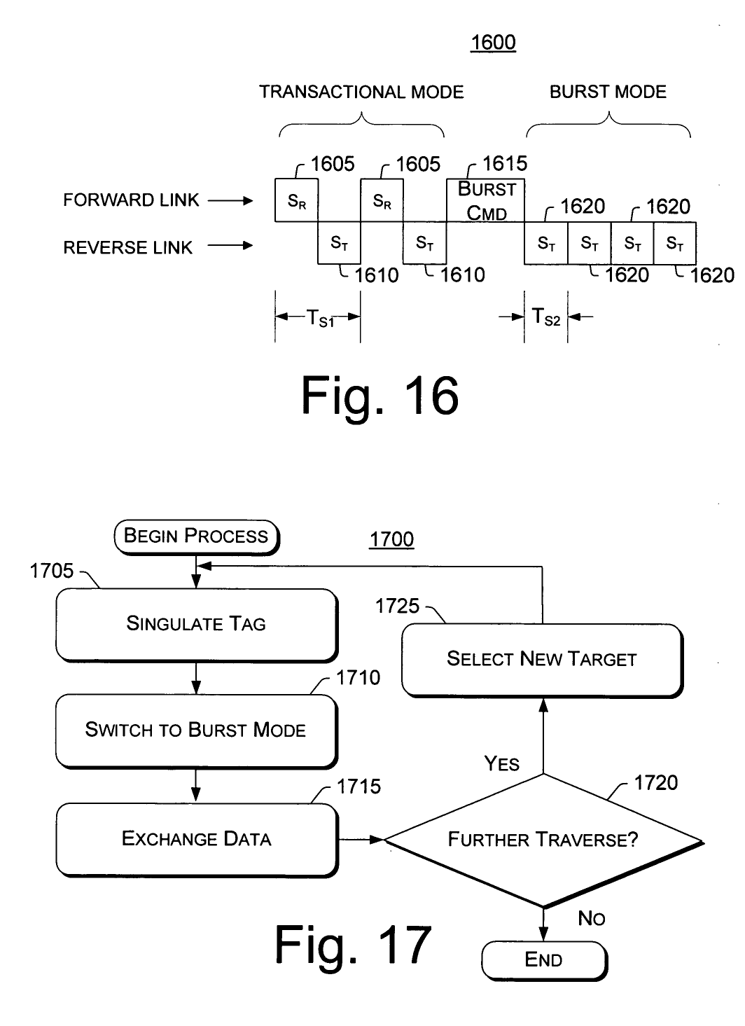

FIG. 16 is a block diagram representing a portion of a signal exchange between one or more RFID tags and an interrogation unit.

FIG. 17 is a flowchart describing a singulation process.

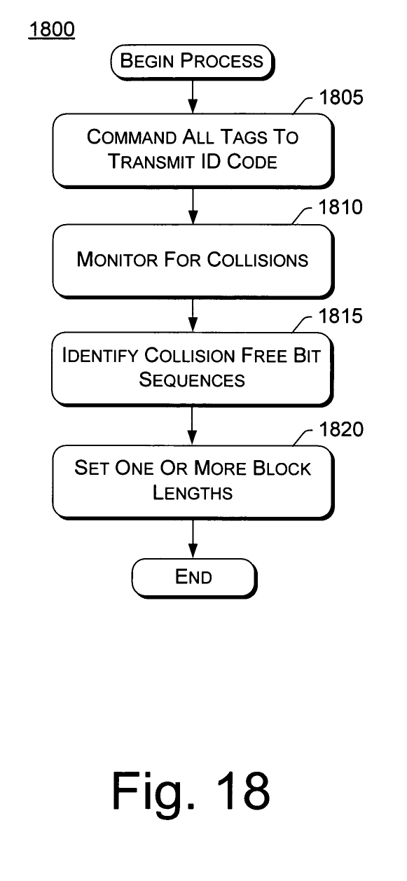

FIG. 18 is a flowchart of a process describing a map mode for determination of collision-free portions of identification code sequences for a population of RFID tags.

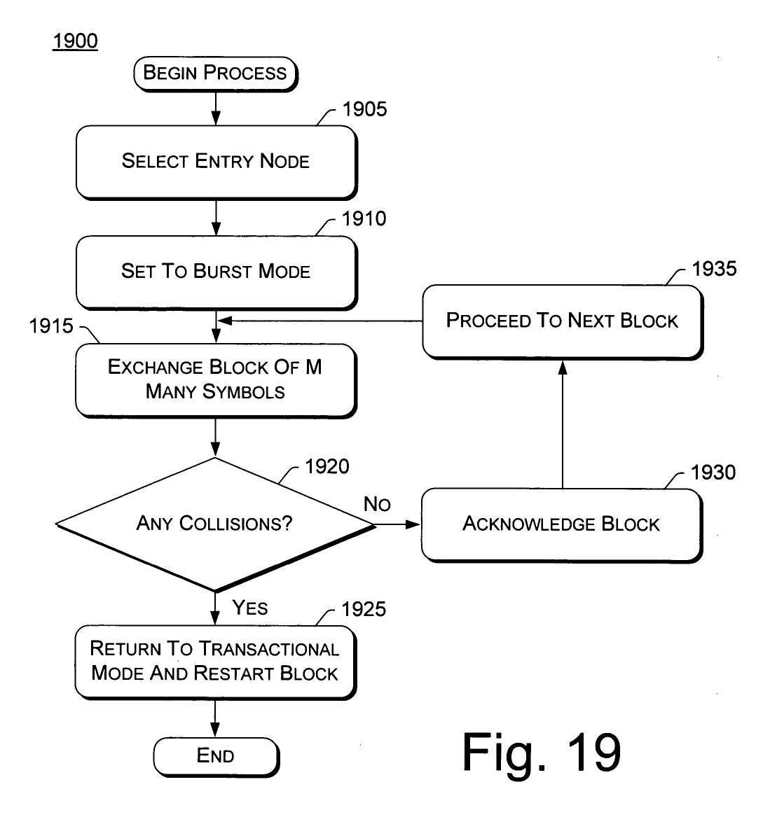

FIG. 19 is a flowchart of a singulation process employing burst mode communications.

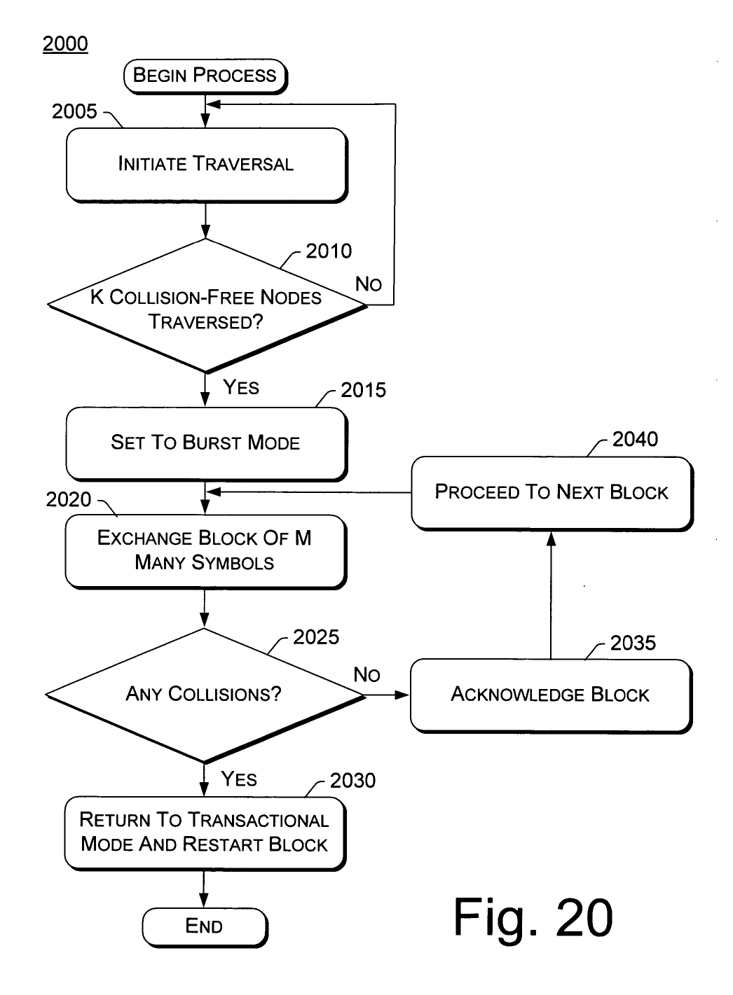

FIG. 20 is a flowchart of a singulation process employing burst mode communications.

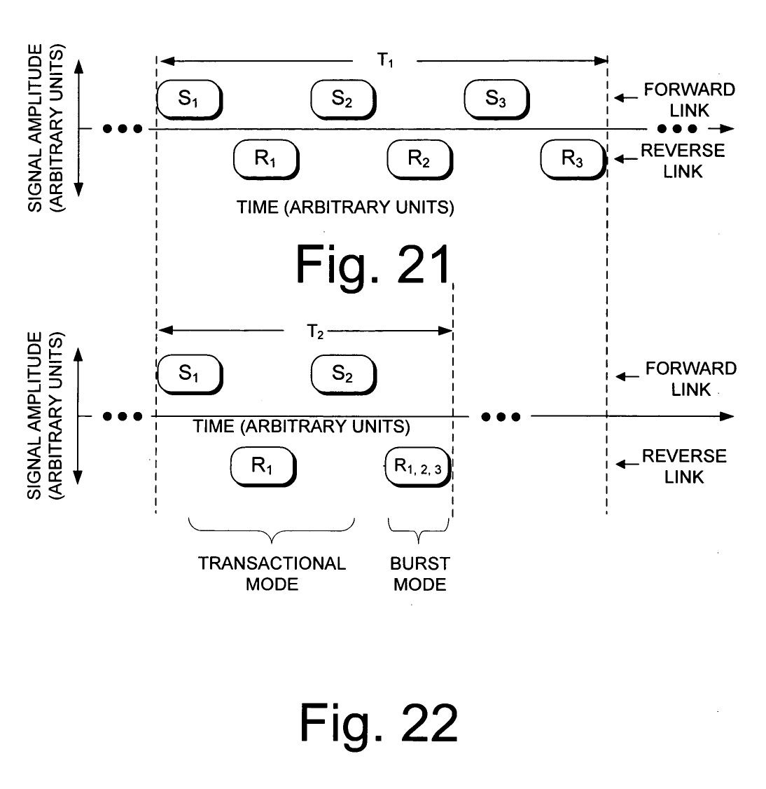

FIGS. 21 and 22 are timing charts providing examples of signal exchanges, such as between an interrogation unit 110 (FIG. 1) and one or more RFID tags 115 within a population of tags 105.

### DETAILED DESCRIPTION

The following disclosure describes improved apparatus, techniques and processes for singulating an RFID tag within a population of RFID tags and effectuating efficient data communications between an interrogation station and one or more RFID tags.

Overview of an RFID System

Prior to describing various embodiments, the following section, including FIGS. 1 and 2, addresses an overview of an architecture for realization of improved data communications in RFID tagging systems. The improved data communications, in turn, promote efficiency in execution of system functions, such as inventorying, programming of, and extraction of information from, individual RFID tags and the like. Within this context, improved RFID systems, RFID tags and communications processes are developed in subsequent sections that facilitate, for example, efficient polling of the RFID tag population.

FIG. 1 is an exemplary block diagram of an RFID tag system 100 including an RFID tag population 105 and an interrogation unit 110. Only one interrogation unit 110 is shown in FIG. 1 for ease of understanding and simplicity of explanation, however, it will be understood that multiple interrogation units 110 may be associated with the system 100 and in data communication with one another as well as with one or more processors or computers (not shown in FIG. 1), via the data path 112. The data path 112 may include any conventional data path, e.g., a radio frequency link, an infrared or other optical link, an acoustic link, serial or parallel bus, telephonic or wideband data link, removable memory devices, and may include intranet, internet, X10 or other communications or information-bearing media.

The RFID tag population 105 includes a plurality of RFID tags 115, e.g., T1, T2, T3, each coupled to a tagged item 120. Systems such as the RFID tag system 100 are desirable for a variety of purposes, such as inventory monitoring and location determination for individual tagged items 120.

In operation of systems 100, the interrogation unit 110 transmits a forward signal 125 to one or more of the population of RFID tags 105 via a forward link. Each individual RFID tag 115 includes one or more antennae 130. Each antenna 130 intercepts a portion of the forward signal 125. The forward signal 125 may convey commands or instructions to the population of RFID tags 105. In some RFID tag systems 100, the forward signal 125 is also employed to supply electrical power to the individual RFID tags 115, to reduce dependence of the individual RFID tags 115 on depletable power sources such as batteries and thus to decrease service requirements (e.g., battery replacement) and to increase mean time to failure of the individual RFID tags 115. The RFID tags 115 then may transmit a reverse signal 135 to the interrogation unit 110 via a reverse link.

All passive RFID tag signaling protocols used in RFID tag systems 100 employ “backscattered” signals for communication between the individual RFID tags 115 and the interrogation unit 110. Modulation of an impedance coupled to the antenna 130 causes a portion of energy associated with the forward signal 125 to give rise to a reverse, re-radiated signal 135 that is able to convey information from the RFID tag 115 back to the interrogation unit 110 via the reverse link. Use of backscattered signaling protocols reduces power requirements for each individual RFID tag 115 because all of the energy in the reverse signal 135 comes from the forward signal 125.

Techniques are needed for addressing specific RFID tags 115 within the population of RFID tags 105. Initially, the RFID tag system 100 may need to determine which RFID tags 115 are within data communications range of the interrogation unit 110. However, when all of the RFID tags 115 in a population of RFID tags 105 concurrently or simultaneously provide response signals 135 having very similar spectral characteristics, the response signals 135 “collide” in a receiver portion of the interrogation unit 110. In conventional RFID tag systems, this results in a situation where the interrogation unit 110 is unable to discriminate between response signals 135 from different RFID tags 115 in the population of RFID tags 105. With some types of signaling systems and processes, as disclosed herein, the interrogation unit 110 is, however, able to determine those portions of the response signals 135 that are collision-free and to discriminate between the collision-free portions and response signal portions that have collided, as is discussed below in more detail.

In one embodiment, the interrogation unit 110 includes one or more processors or CPUs 150, the data path 112 and memory 155 coupled to the one or more processors 150. The memory 155 is configured to store identification code information, status information relative to the population 105 and program modules including operating instructions.

The interrogation unit 110 also may include a first receiver RX₁ 160 having a first antenna 165 coupled thereto, a second receiver RX₂ 170 coupled to the one or more processors 150 and having a second antenna 165 coupled thereto, a third receiver RX₃ 175 having a third antenna 165 coupled thereto, a fourth receiver RX₄ 180 having a fourth antenna 165 coupled thereto, an N−1^{TH} receiver 185 having an N−1^{TH} antenna 165 coupled thereto, an NTH receiver 190 having an NTH antenna 165 coupled thereto. The interrogation unit 110 also includes a transmitter TX 195 coupled to the one or more processors 150 and having a transmitter antenna 197 coupled thereto.

The first receiver RX₁ 160 operates at a first frequency f₁ and the second receiver RX₂ 170 operates at a second frequency f₂ that is offset from the first frequency f₁, with the other receivers having analogous but differently-offset frequencies. The number of receivers RX need not be a multiple of two. It will be appreciated that the antennae 165 may be separate antennae or may comprise a common antenna 165. The RFID tags 115 transmit first symbols, such as a “1”, using the first frequency f₁, and transmit second symbols, such as a “0”, using the second frequency f₂. Similarly, multiple bits may be communicated via a single symbol transmission by designating bit combinations to correspond to each frequency, e.g., f₁ corresponds to “00”, f₂ corresponds to “01”, f₃ corresponds to “10” and so forth. Frequency diversity in the receivers 160, 175, 175 . . . 190 associated with the interrogation unit 110 is favored because relatively few interrogation units 110 are typically required and because multiple subcarrier frequencies can be implemented within stringent power budget and physical constraints associated with the RFID tags 115. The interrogation unit 110 does not have the power budget and other physical constraints imposed on the RFID tags 115 and thus is able to support relatively robust receivers in comparison to those deployed in the RFID tags 115.

When the one or more processors 150 determine that two or more of the receivers 160, 175, 175 . . . 190 are receiving symbols at the same time, a collision between transmissions from two or more RFID tags 115 has occurred. Collisions result in reduction or loss of intelligibility in conventional interrogation processes.

Techniques for selectively enabling data communications between individual RFID tags 115 and the interrogation unit 110 typically involve sending signals from the interrogation unit 110 to the population of RFID tags 105 that cause selected portions of the population of RFID tags 105 to enter a “mute” state, that is, to abstain from providing modulated response signals 135 until a later time or a command resets them. By sequentially transmitting a series of commands, each selecting and sequestering together different portions of the population of RFID tags 105 by causing these portions to enter a mute state and thus to refrain from providing modulated response signals 135, the interrogation unit 110 is able to winnow or narrow the population of RFID tags 105 in the traverse state until only one selected RFID tag 115 (or a selected subset of RFID tags 115) is in data communication with the interrogation unit 110. This process is called “singulation” of the selected RFID tag 115.

Typically, singulation relies on singulation confirmation by transmission of a signal to the interrogation unit 110 that includes data unique to the RFID tag 115 being singulated, such as a serial number that is associated only with the singulated RFID tag 115. When that transmission is acknowledged by the interrogation unit 110, the RFID tag 115 associated with the unique data has been singulated. The RFID tag 115 and the interrogation unit 110 then can exchange data or commands with some assurance that one-to-one data communications have been established.

Various prior art systems and methods have been employed to address RFID tag polling and data communications functions, and different types of algorithms have been developed for singulation of individual RFID tags 115. An example of a binary tree traversal protocol is described below with reference to FIG. 2.

FIG. 2 is a schematic diagram showing a hierarchy 200 of the RFID tags 115 of FIG. 1, organized into a binary tree structure according to an exemplary seven bit identification number. It will be appreciated that typical RFID tag 115 identification codes may be extremely lengthy, because they may include information identifying a manufacturer for the RFID tag 115, a serial number for the RFID tag 115 and the like. RFID tags 115 may have identification codes of several hundreds of bits in length.

A node 205 is designated as the root, and corresponds, for example, to a most significant bit in the identification code (e.g., node level 0). Branches, such as 210, correspond to additional bits of the identification or serial number in sequence, as denoted in the node levels placed on the levels of the corresponding nodes. The branches 210 each are associated with a legend “1” or “0”, according to the bit value represented by that branch. The branches 210 lead to nodes, such as branch nodes 215, 217, 220, 225 and 235, and leaf nodes 240. A branch node is a node such as 235 having more than one path extending below it that is populated. Leaf nodes 240 correspond to specific RFID tags 115 (FIG. 1), such as, for example, the leaf node 240 with the identification or serial number 1010111 (far left of FIG. 2). The binary tree of FIG. 2 is shown as being divided into two groups of leaves, denoted α and β, for purposes of illustration, as will become evident from the examples given below with respect to subsequent Figs. The example of FIG. 2 does not show in detail all of the leaf nodes 240 corresponding to a seven bit serial number or pseudo identification code for simplicity of illustration and ease of understanding.

Pseudo identification codes may be employed in some systems in order to provide each RFID tag 115 in a population 105 with a unique identification code without having to employ an ID code that is longer than is necessary. For example, when it is known that fewer than 1024 RFID tags 115 are needed in a given system application, a pseudo identification code that is only ten bits in length is sufficient to permit each of the RFID tags 115 in the population 105 to be associated with a unique pseudo identification code. The term “ID code” will be employed hereinafter for simplicity of explanation and ease of comprehension, with the understanding that, unless otherwise indicated, such may include the meaning of or be interchangeable with the terms “ID code”, “serial number”, “unique ID” and “pseudo ID code” or “pseudo identification code” within its meaning as intended herein.

Algorithms known as “binary tree traversal” algorithms offer ability to parse a population 105 of RFID tags 115 in order to identify RFID tags 115 within the population 105 and to permit data exchange between one or more RFID tags 115 in the population 105 and the interrogation unit 110. Examples of such systems are described in U.S. Patent Application Serial No. U.S. 2002/0149481 A1, published on Oct. 17, 2002, entitled “Method, System, And Apparatus For Binary Tree Traversal Of A Tag Population”, naming Shanks et al. as inventors, U.S. Patent Application Serial No. U.S. 2002/0167405 A1, published on Nov. 14, 2002, entitled “Radio Frequency Identification Structure”, naming Shanks et al. as inventors and U.S. Pat. No. 6,535,109, entitled “System And Method For Communicating With Multiple Transponders”, naming Mahdavi as inventor, which are all hereby incorporated herein by reference.

Briefly, such algorithms involve a series of short transactions between the interrogation unit 110 and the RFID tag population 105. Each transaction involves an exchange of signals between the RFID tag population 105 and the interrogation unit 110, such as a signal 125 transmitted from the interrogation unit 110 followed by a response signal 135 from one or more of the RFID tags 105, or, in some cases, a lack of such a response signal 135.

Binary tree algorithms operate by having the interrogation unit 110 initially transmit the forward signal 125 configure to include a command to the population of RFID tags 105 to cause the RFID tags 115 to enter a “traverse” state. In the traverse state, the RFID tags 115 respond to the forward signal 125 by sending back the reverse signal 135 which may be configured to include information such as data corresponding to a predetermined bit of an ID code for each of the RFID tags 115 in the population 105.

When the interrogation unit 110 is able to employ information in the reverse signal 135 to determine that both branches 210 extending immediately below the root node 205 are populated, i.e., are coupled via one or more branches 210 to a leaf node 240 corresponding to an RFID tag 115, the interrogation unit 110 may transmit a signal configured to cause a subset of the population of RFID tags 105, such as all RFID tags 115 on one branch 210 extending from the root 205 (e.g., the subset having a first bit of their serial number equal to “0”), to leave the traverse state and enter a mute state (become dormant). These RFID tags 115 then do not respond to further forward signals 125 while in the mute state.

The signal from the interrogation unit 110 is also configured to cause another subset (e.g., the subset having a first bit of their serial number equal to “1”) to remain in the traverse state and thus to continue to be able to provide a response signal.

The interrogation unit 100 then transmits another command configured to cause a further subset of the population 105 to become dormant (e.g., the subset having a second bit of their serial number equal to “1”) and to cause another subset (e.g., the subset having the second bit of their serial number equal to “0”) to provide a response signal. RFID tags 115 corresponding to leaf nodes 240 that are below a given branch node and that are coupled to that branch node via one or more branches 210 that do not extend above the branch node are “associated” with that branch node.

The interrogation unit 110 continues to send such commands until only a single RFID tag 115 is active or singulated. The interrogation unit 110 and the singulated RFID tag 115 then can exchange information and/or commands as appropriate, while affording confidence that the exchange is between a specific one of the RFID tags 115 and the interrogation unit 110. Conventional binary tree traversal algorithms have some disadvantages, in part because they parse the binary tree by only a single node level per transaction.

Conventional binary tree traversal algorithms have some inefficiency. First, the time to singulation each RFID tag is made longer by the limitation of parsing the binary tree at a single node per transaction. Second, time to singulate a group of RFID tags is adversely impacted by returning to the root 205 following singulation of a leaf node 240 and any subsequent communication between a given RFID tag 115 and the interrogation unit 110.

For example, the types of systems described in the above-noted documents return to the root 205 following singulation of a leaf node 240 and any subsequent communication between the singulated RFID tag 115 and the interrogation unit 110. The binary tree must then be traversed again, beginning from the root 205, in order to singulate a second RFID tag 115, resulting in inefficiency and delay, particularly when the tree is densely populated. Further, in a large RFID tag population 105, many or all of the RFID tags 115 will include common bit sequences (such as manufacturer identification) as a portion of the bit sequence employed to verify singulation of a specific RFID tag 115 within the population 105.

As a result, repeated transmission of the common bit sequences in conventional transactional signaling protocols contribute to the amount of time required to poll the population 105 of RFID tags 115.

Exemplary Branch Node Indexing Processes

FIG. 3A is a flowchart describing a process 300 for transmitting re-entry node information to a population 105 of RFID tags 115. The process 300 begins by designation of re-entry node information, such as a predetermined number N or a list designating a subset of branch nodes 215, 217, 225, 235 in the binary tree as “re-entry” nodes in a block 305. The designation of block 305 may be adopted during operation of the RFID tag system 100 of FIG. 1 or may be preset.

When the designation of block 305 is adopted during system operation, the interrogation unit 110 transmits re-entry node identification information, or a list of re-entry nodes, to the population of tags 105 in a block 310. Each of the RFID tags 115 then stores the re-entry node identification information in a memory (not shown in FIG. 1), which may be volatile or non-volatile, in the RFID tag 115 in a block 315. The process 300 then ends.

Non-Tracking and Tracking Tag Re-Entry Processes

FIGS. 3B and 3C show tables describing processes for determining re-entry node information in an RFID tag system. FIG. 3B describes non-tracking tag re-entry processes. FIG. 3C describes tracking tag re-entry processes.

In one embodiment, the process illustrated in FIG. 3B relies on tracking of nodes by the interrogation unit 110 but not by the RFID tags 115 in traversing the hierarchy 200 of FIG. 2. Initially (i.e., corresponding to the top lines of the chart of FIG. 3B), the RFID tags 115 are all dormant. A command transmitted from the interrogation unit 110 places the RFID tags 115 in a traverse mode.

The traversal process comprises transmission of a forward symbol from the interrogation unit 110 to the RFID tags 115, followed by a reverse symbol transmitted from the RFID tags 115 back to the interrogation unit 110. In this example, at node #1, the interrogation unit 110 transmits a ONE, and each of RFID tags 115 A, B and C transmits a reverse symbol corresponding to a first bit of each of their individual identification codes, which in this example is also a ONE for each of these RFID tags 115. Thus, there is no “collision”, that is, the same bit value is transmitted by each of the RFID tags 115.

The interrogation unit 110 then transmits a second bit, corresponding to node #2, and the RFID tags 115 transmit a second bit of each of their identification codes in return via the reverse path. However, at node 4, RFID tags 115 A and B each transmit a ONE, while RFID tag 115 C transmits a ZERO via the reverse link, in other words, a “collision” signals to the interrogation unit 110 that node 4 is a branch node.

The interrogation unit 110 then “asks for the ones”, that is, transmits a ONE, and the RFID tag 115 C is muted by this. In this example, the RFID tags A and B return a ONE and a ZERO, respectively, indicating that node 5 is also a branch node.

The interrogation unit 110 then again “asks for the ones”, which places RFID tag 115 B into the mute state, in addition to RFID tag 115 C and, in this example, results in the RFID tag 115 A transmitting back a ZERO as the least significant bit in the identification code for RFID tag 115 A. RFID tag A is now singulated and the interrogation unit 110 has identified nodes 4 and 5 as branch nodes. The interrogation unit 110 has determined that the RFID tag 115 A is present in the interrogation arena defined by the area within which the interrogation unit 110 and the RFID tags 115 are able to maintain communications.

The interrogation unit 110 then transmits a command to reset the RFID tags 115 to node #4. The RFID tag 115 A has been singulated and so remains in a mute state, and the RFID tags 115 B and C transmit a ONE and a ZERO, respectively, representing another collision. In this example, the interrogation unit 110 then “asks for the zeroes”, which places RFID tag 115 B in a mute state and causes RFID tag 115 C to provide a ZERO for node 5, i.e., to singulate the group β of FIG. 2. The interrogation unit 110 then traverses node 6, obtaining a return signal from RFID tag 115 C of a ZERO and thus singulating RFID tag 115 C.

The interrogation unit 110 then again sends a command to the RFID tags 115 to restart from node #4. In this example, RFID tags A and C are now dormant, having been singulated, and so the interrogation unit is able to singulate RFID tag 115 B via a similar series of transactions. It will be appreciated that, in this mode of operation, the order in which RFID tags 115 B and 115 C are singulated is determined by the interrogation unit 110, and, in either instance, in this example, the interrogation unit 110 will cause the RFID tags 115 to restart from a predetermined node, such as node #4 in this example, via a command.

In one embodiment, the process shown in FIG. 3C relies on tracking of nodes by the interrogation unit 110 and by the RFID tags 115 in traversing the hierarchy 200 of FIG. 2. Initially (i.e., corresponding to the top lines of the chart of FIG. 3B), the RFID tags 115 are all dormant. A command transmitted from the interrogation unit 110 places the RFID tags 115 in a traverse mode.

As noted above with reference to FIG. 3B, the interrogation unit 110 and the RFID tags 115, A, B and C traverse to node #4, where a first collision is noted by the interrogation unit 110. Similarly, a second collision is subsequently noted at node #5. However, in contrast to the process illustrated in FIG. 3B, the point for restarting is adjustable, and, in the embodiment described by FIG. 3C, a command to restart at node #5 (i.e., node 225 in FIG. 2) facilitates more rapid singulation of RFID tag 115 B after singulation of RFID tag A by not having to restart from the last node corresponding to all responding RFID tags, or, in this example, node #4.

RFID tag 115 C then may be efficiently singulated by resetting the process to node #4, however, since RFID tags A and B have been singulated and thus are mute. So, by having the RFID tags 115 incorporate a memory function, which may be a volatile memory function, the RFID tags 115 promote increased efficiency in parsing of the binary tree 200 of FIG. 2. In this example, such is effectuated by parsing the group of leaves denoted α in FIG. 2 and then parsing the group of leaves β, however, it will be appreciated that other patterns may be employed and may be desirable under other circumstances and/or criteria. The scenario depicted in FIG. 3C permits the interrogation unit 110 of FIG. 1 to transmit fewer bits in traversing a population of RFID tags 115, as represented by the binary tree 200 of FIG. 2. In systems where the identification code for the RFID tags 115 comprises many bits, such as 128 or 256 bits or more, efficiency may be at a premium.

FIG. 4 is a flowchart describing a process 400 for repeated leaf node 240 singulation. The process 400 begins in a block 405.

In the block 405, a command from the interrogation unit 110 sends a command to place all or some of the RFID tags 115 in a traverse mode. In one embodiment, the command also designates either the root node 205 or one of the re-entry nodes as a starting node, with RFID tags 115 not associated with the starting node being placed in a mute state.

In a block 410, the process 400 traverses to and singulates a leaf node 240. The singulation of the leaf node 240 may follow a conventional protocol or another leaf node 240 singulation protocol.

Some types of signaling protocols implicitly provide information regarding leaf node 240 population during traversal of branch nodes. For example, when FSK systems are used, the signals from the RFID tags 115 associated with the serial numbers 1010111 and 1010110 (left side of FIG. 2) will inform the interrogation unit 110 that both associated leaf nodes 240 are populated when the last bits of each serial number are transmitted back to the interrogation unit. In other types of signaling protocols, this information may not be available, and in such systems, the acts described with respect to a query task 420 and blocks 425 and 430 may be desirable.

In the query task 420, the process 400 determines when a response signal from an RFID tag 115 corresponding to the singulated leaf node 240 is received. Typically, an identification code corresponding to the singulated leaf node 240 is used to verify singulation. Transmission of a signal from a specific RFID tag 115 corresponding to the singulated leaf node 240 back to the interrogation unit 110 is an affirmative indication of presence of the specific RFID tag 115 in the population 105 of RFID tags 115.

When the query task 420 determines that a response signal is received, and thus that the RFID tag 115 is in the population of RFID tags 105, data communications may be initiated between the RFID tag 115 corresponding to the singulated leaf node 240 and the interrogation unit 110 in the block 425. The data communication may be employed to store information in the RFID tag 115 for later retrieval, to provide additional programming or instruction modules to the RFID tag 115, to establish mutual calibration (e.g., set a current date/time) or to extract information from the RFID tag 115.

Information from the RFID tag 115 may include operational information regarding the RFID tag 115 itself (e.g., indication of malfunction), status information (e.g., interval since last polled), stored information (such as addressing or ownership information relative to the tagged item), special handling information (e.g., temperature or time sensitive material, chemical hazard) or environmental information such as temperature, temperature history, acceleration, positional data (geographic or orientational), optical, moisture or chemical information and the like. When the data communication is finished, control passes to a block 435.

When the query task 420 determines that no response signal is received, or when signals received during traversal of branch nodes identify that a leaf node 240 is not populated, control passes to the block 430. The system 100 may store information that no RFID tag 115 corresponds to the identified leaf node 240 in the block 430 when no return verification signal is received by the interrogation unit 110 in response to leaf node 240 singulation. Control then passes to the block 435.

In the block 435, the RFID tags 115 go to a re-entry node. In one embodiment, the interrogation unit 110 transmits a command to set the RFID tags 115 to a specific entry node.

In one embodiment, the RFID tags 115 return to a re-entry node that is closest to the singulated leaf node 240. For example, if the nodes 225 and 225′ of FIG. 2 were designated as re-entry nodes during the process 300, and the block 410 singulated the RFID tag 115 associated with the serial number “1010111” (far left of FIG. 2), all of the other RFID tags 115 would be in the “mute” state.

The block 435 then would result in the RFID tags 115 returning to the branch node 225. The RFID tags 115 associated with the serial numbers “1010111”, “1010110” and “1010101” would leave the mute state while the RFID tag 115 not associated with the re-entry node 225 (associated with serial number “1010000”) would remain in the mute state.

In a query task 440, the process 400 determines when all of the RFID tags 115 associated with that re-entry node have been accounted for, that is, either interrogated or found to be absent from the population 105. When the query task 440 determines that not all of the RFID tags 115 associated with that re-entry node have been accounted for, control passes back to the block 410. This permits the remaining RFID tags 115 corresponding to leaf nodes 240 associated with the re-entry node 225 to be successively singulated.

When the query task 440 determines that all of the RFID tags 115 associated with that re-entry node have been accounted for, control passes to a query task 445.

In the query task 445, the process 400 determines when all desired leaf nodes 240 have been singulated. When the query task 445 determines that not all desired leaf nodes 240 have been singulated, control passes to a block 450.

In the block 450, the interrogation unit 110 selects another re-entry node. Control then passes back to the block 410 and the process 400 iterates. The process 400 may re-initiate traversal of the tree from the root node 205 or another designated node, but proceeds to and then through the next selected re-entry node. The RFID tags 115 associated with the next selected re-entry node automatically return to that re-entry node and leave the mute state following indication of termination of data exchange between the RFID tag 115 associated with the singulated leaf node 240 because the re-entry node was among those designated during the process 300.

Continuing with the example, the block 450 selects the re-entry node 225′. The process 400 then results in singulation of the RFID tag 115 associated with the serial number “1010000” (far right of FIG. 2).

When the query task 445 determines that all desired leaf nodes 240 have been singulated, the process 400 ends. The example facilitates efficient traversal of the binary tree 200 because node levels “0” through “4” need only be traversed twice in singulation of the four RFID tags 115.

In one embodiment, in the block 450, the interrogation unit 110 sends a command to reset the population of tags 105 to a designated re-entry node 215, 217, 225, 235. In one embodiment, only RFID tags 115 associated with or emanating from the designated re-entry node 215, 217, 225, 235 respond in further RFID tag singulation until a different re-entry node 215, 217, 225, 235 is designated, a command to switch to another mode of operation is transmitted or a master reset (e.g., “return to root 205”) command is transmitted. Other RFID tags 115 in the population 105 remain in a mute or dormant state until reset. Control then returns to block 410 and the process 400 iterates.

Designated Re-Entry Node Mode

The RFID tag system 100 can also transmit a designation of a re-entry node based on knowledge of how RFID tags 115 are distributed in the tree or knowledge of common bit sequences for the tag population 105 (an example of which is discussed below with reference to FIG. 5). For example, assume that the population 105 of tags comprises the four leaf nodes 240 shown in FIG. 2 as having identification numbers associated with them.

Initially, the RFID tag system 100 may singulate the leaf node 240 corresponding to the identification number 1010111. Following singulation of the leaf node 240 corresponding to identification number 1010111 (block 410), the interrogation unit 110 transmits a command such that the node 235 becomes the branch node, because the RIFD tag system 100 has knowledge that the leaf node 240 corresponding to identification number 1010111 has a neighboring leaf node 240 that is populated, e.g., the leaf node 240 corresponding to identification number 1010110. Following singulation of both of the leaf nodes 240 corresponding to identification numbers 1010111 and 1010110 (block 410), the interrogation unit 110 transmits a command such that the node 225 becomes the branch node.

When, however, the RFID tag system 100 begins identification of individual RFID tags 115 by singulation of the leaf node 240 corresponding to the identification number 1010000, the interrogation unit 110 transmits a command such that the branch node 220 at node level 4 becomes the new re-entry node.

Tracked List Mode

In one embodiment, a mode of operation is adopted where both the interrogation unit 110 and the RFID tags 115 maintain information regarding the population 105 in the binary tree. In this mode, the block 450 comprises a return to a re-entry node corresponding to the nearest or “neighboring” branch node 215, 217, 225, 235 associated with leaf nodes 240 that have not yet been singulated. The RFID tags 115 automatically return to the neighboring re-entry node following indication of singulation of a leaf node 240.

RFID tags 115 not associated with the re-entry node remain in a mute or dormant state. RFID tags 115 associated with the re-entry node are in a traverse state and respond to traverse commands from the interrogation unit 110.

In one embodiment, the interrogation unit 110 is able to monitor for collisions, and thus determine which nodes are or are not branch nodes, by determining when more than one of the receivers RX₁ 160-RX_{N} 190 is active and can then transmit such information to the RFID tags 115. A counter or stack in each of the RFID tags 115 allows the RFID tags 115 to track the traversal process.

One way for the interrogation unit 110 to keep track of appropriate re-entry nodes is to push a “0” onto a memory or stack when a node level is traversed that is not a branch node and to push a “1” onto the stack when a node level is traversed that is a branch node. At each branch node 215, 225, 235, the interrogation unit 110 sends “push” commands to the tag population 105.

In response, the RFID tags 115 “push” a “1”, indicating a branch node such as node 225, or a “0”, indicating a non-branch node such as node 215, onto a stack. Individual RFID tags 115 then can determine when they are permitted to respond to traversal commands from the interrogation unit 110 and when they are to remain in a mute or dormant state. When a leaf node 240 has been singulated, the RFID tags 115 and the interrogation unit 110 can then jump together to the nearest branch node and employ that branch node as a re-entry node.

When one or more RFID tags 115 become “lost”, i.e., the associated counters or stacks lose synchronization with the interrogation unit 110 or other RFID tags 115, the interrogation unit 110 will detect multiple return signals 135 from multiple RFID tags 115 and can provide appropriate commands to restore synchronization. For example, the interrogation unit 110 can provide a command to return to the root node 205 or to another designated re-entry node 215, 225, 235. Alternatively, the interrogation unit 110 may periodically cause a return to the root node 205.

N-Bit Neighbor Node Mode

In an N-bit neighbor mode of operation, the new re-entry branch node is chosen to be a number N of bits away from the singulated leaf node 240 or the previous re-entry branch node 215, 225, 235, such as two bits, three bits, four bits or the like, corresponding to a respective branch node in node level 5, 4, 3 or the like. The number N may be fixed or may be changed by a command from the interrogation unit 110. The number N may be a relatively large number, such as 20. The process 300 of FIG. 3 may be employed to communicate the number N to the individual RFID tags 115 in the block 310, or the RFID tags 115 may be pre-programmed with the information setting the number N.

Designated Branch Node Mode

In one embodiment, the interrogation unit 110 pushes a “0” onto a stack to designate non-branch nodes and pushes a “1” onto the stack to designate branch nodes. Following singulation of a leaf node 240, the interrogation unit 110 “pops” values off of the stack until it reaches a “1” and keeps track of the number of values that have been popped off of the stack, and the interrogation unit 110 then transmits information corresponding to that node or to the number of nodes separating that node from the singulated leaf node 240 to the individual RFID tags 115 to cause them to reset to the new re-entry node.

Single Step Mode

In one embodiment, the interrogation unit 110 sends a single level command to cause the individual RFID tags 115 to step back one node level from the last singulated leaf node 240. The single level command may comprise a single bit transmitted by the interrogation unit 110. More than one such command may be employed to cause the individual RFID tags 115 to step back more than one node level.

Multiple Step Mode

In one embodiment, the interrogation unit 110 sends a multi node level command to cause the individual RFID tags 115 to step back M many node levels from the last singulated leaf node 240 to a new re-entry node. The multi node level command may comprise an M-bit command transmitted by the interrogation unit 110.

Tracked Branch Node Mode

In one embodiment, the interrogation unit 110 transmits a command while traversing a branch node that will be employed as a new re-entry node. The individual RFID tags 115 store this information and also keep track of a present node.

Following singulation of a particular leaf node 240, the interrogation unit 110 transmits a command to cause all of the RFID tags 115 to return to the new re-entry node. This embodiment requires that each RFID tag 115 have a stack or counter for tracking of the new re-entry node.

The process 400 obviates need for a return to the root 205 for each RFID tag 115 singulation. Accordingly, speed of traversal of the population 105 is increased, repetitive broadcasts of bit sequences common to subsets of the population 105 are decreased and bandwidth efficiency is improved.

FIG. 5 is a flowchart describing a process 500 for determining common bit sequences in a population 105 of RFID tags 115 and for setting entry nodes in a binary tree mapping of the RFID tag population 105. The process 500 begins in a block 505.

In the block 505, the interrogation unit 110 sends a command to cause all of the RFID tags 115 in the population 105 to transmit their identification codes contemporaneously, that is, in relatively close synchrony.

In one embodiment, the command causes the RFID tags 115 to transmit the identification codes in a burst mode, which may include the entire identification code or a portion of the identification code. In one embodiment employing backscatter for the reverse link, the interrogation unit 110 then transmits a carrier. In a block 510, the interrogation unit 110 monitors the identification codes transmitted back from the RFID tags 115.

In a block 515, the interrogation unit 110 determines collision-free portions of the identification codes. This requires that the RFID tags 115 transmit such that at least a portion of each bit position from each of the RFID tags 115 overlap the same bit position in the sequence from the other RFID tags 115. In one embodiment, the interrogation unit 110 detects collisions by determining those bit positions where transmitted or backscattered energy is present at more than one of the receivers RX₁ 160 through RX_{N} 190.

In a block 520, the interrogation unit 110 sets entry nodes based on the collision-free portions of the identification codes. For example, the population 105 of four RFID tags 115 shown in FIG. 2 could employ the branch node 215 of node level 4 or the branch nodes 215 and 235 of node level 5 as re-entry nodes, to avoid repeatedly traversing node levels 0, 1, 2 and 3 in serially singulating the population 105 of RFID tags 115. Other techniques could be employed for determining when collisions occur. The process 500 then ends.

Exemplary NFSK Multi-Node Branch Indexing

FIG. 6 represents a portion 600 of a binary tree. The portion 600 includes three node levels, denoted N-2, N-1 and N, and illustrates four leaf nodes, analogous to the leaf nodes 240 of FIG. 2. The four leaf nodes are denoted Tag A (00), Tag B (01), Tag C (10) and Tag D (11). FIG. 7 is a graph 700 of power versus frequency illustrating four subcarrier frequencies F₀, F₁, F₂ and F₃. Arrows illustrate a relationship between the bits corresponding to the four RFID tags (Tag A, Tag B, Tag C and Tag D) represented in FIG. 6 and the four subcarrier frequencies F₀, F₁, F₂ and F₃ represented in FIG. 7, respectively. It will be appreciated that, while FIGS. 6 and 7 depict four leaf nodes Tag A (00), Tag B (01), Tag C (10) and Tag D (11) and four subcarrier frequencies F₀, F₁, F₂ and F₃, respectively, for simplicity of illustration and ease of understanding, the concepts disclosed may be applied to other numbers of nodes and/or subcarrier frequencies.

FIG. 8 is a block diagram of an exemplary RFID tag communications system 800 that may be contained in each of the RFID tags 115 of FIG. 1 and that is useful in the context of the subcarrier frequency signaling arrangement of FIGS. 6 and 7. The RFID tag communications system 800 includes an antenna 805 coupled to an RF interface 810. The RF interface 810 is coupled to a modulator 815 and a demodulator 820. The modulator 815 is coupled to a subcarrier frequency generator 825, which, in turn, is coupled to an oscillator 830. The RF interface 810 is also optionally coupled to a DC power recovery module 835. Control logic 840 is coupled to the subcarrier frequency generator 825, the modulator 815 and the demodulator 820. A memory 845, which may include read-write memory and non-volatile memory, is coupled to the control logic 840 and is configured to store data received from the control logic 840 and to retrieve data and provide retrieved data to the control logic 840. The memory 845 is also configured to store identification code information and program modules including operating instructions.

When forward signals 125 (FIG. 1) are received by the antenna 805, the DC power recovery module 835 rectifies a portion of the forward signals 125 to provide DC power to a remainder of the RFID tag communications system 800. The demodulator 820 receives a portion of the forward signals 125 and provides commands and information from the forward signals 125 to the control logic 840. The control logic 840 responds by providing responses to the modulator 815 and/or subcarrier frequency generator 825. As a result, reverse signals 135 are transmitted back to the interrogation unit 110.

The oscillator 830 is synchronized to a component of the forward signals 125, such as a pattern in the forward signals 125. This provides an accurate oscillator signal at a first frequency to the subcarrier frequency generator 825. The subcarrier frequency generator 825 provides one or more signals to the modulator 815 that are derived from the first frequency signal from the oscillator 830. For example, the oscillator 830 may provide a signal at a frequency of 5 Megahertz. The subcarrier frequency generator 825 may include a group of frequency dividers and use these to derive signals F₀, F₁, F₂ and F₃, for example, having frequencies of 1.25 Megahertz, 2.5 Megahertz, 3.75 Megahertz and 5 Megahertz, respectively. In one embodiment, the subcarrier frequency generator 825 provides three or more signals to the modulator 815.

FIG. 9 is a flowchart describing an interrogation unit 110 process 900 for traversing a population 105 of RFID tags 115 that is useful in the context of the N-FSK signaling protocol described with reference to FIGS. 6, 7 and 8. The RFID tag 115 may transmit multiple bits of information in a single symbol to the interrogation unit 110. For example, a signal corresponding to F₀ indicates that “00” is being transmitted, with F₁ corresponding to “01”, F₂ corresponding to “10” and F₃ corresponding to “11”. This example increases the data rate of transmissions from the RFID tag 115 to the interrogation unit 110 by a factor of two.

The process 900 begins in a block 905. In the block 905, the interrogation unit 110 transmits a command to place the RFID tags 115 in a traversal mode or a sort mode and to synchronize the RFID tags 115 with the interrogation unit 110. For example, the RFID tags 115 are set to an entry node corresponding to an entry node employed by the interrogation unit 110.

With reference to FIG. 2, such would be one of nodes 215, 217, 220, 225 or 235 (as discussed above) or the root node 205. This example is described in terms of a start from the root node 205, with the portion 600 of the tree of FIG. 6 corresponding to node 225 of FIG. 2 and elements below node 225 (e.g., node 225 corresponding to node level N-2, node 235 corresponding to node level N-1 etc.).

In a block 910, the interrogation unit 110 polls the population of RFID tags 115 by transmitting a carrier signal. The carrier signal may also act to provide or supplement DC power for the RFID tags 115.

In a block 915, the interrogation unit 110 analyzes information from the RFID tags 115. For example, the RFID tags 115 transmit a first two bits of their ID codes.

In a block 920, the interrogation unit 110 transmits a signal 125 comprising multiple bits of a target path. This signal acts to poll the population 105 of RFID tags 115 or a subpopulation of the RFID tags 115 not in a mute state and places those RFID tags 115 not associated with the target path in the mute state. For example, the interrogation unit 110 polls the population 105 of RFID tags 115 by transmitting information representing a first N many bits of a target path, such as ‘10’ and then transmits a carrier.

In a block 925, the interrogation unit 110 receives signals from the RFID tags 105 that are on the target path comprising N many bits of an identification code, such as the next two bits (corresponding to the example of FIGS. 6 and 7). Each of the RFID tags 115 backscatters N many bits as a single bit length symbol modulated using one of the subcarrier frequencies F0, F1, F2 and F3. In the example of FIG. 2, each of the RFID tags Tag A, Tag B, Tag C and Tag D would all backscatter a single bit symbol at the subcarrier frequency F2. RFID tags 115 that do not have these bits set to the target path value (i.e., to ‘10’ in this example) would be placed in a “mute” or non-responsive state by this sequence of signals.

In a block 930, the interrogation unit 110 analyzes the information contained in the reverse signals 135 from the RFID tags 115 that are not in the mute state. The interrogation unit 110 can determine when no signal 135 is returned, one or more signals 135 are returned that carry the same data (because there are no collisions) or when multiple signals 135 are returned that carry different data (because there are collisions, i.e., signals corresponding to more than one of the subcarrier frequencies are present).

In a query task 935, the process 900 determines when a leaf node has been singulated or is within a threshold value of being singulated. When the query task 935 determines that the leaf node has not been singulated or that the process 900 is not within a threshold value of being singulated, control passes to a block 940. When the query task 935 determines that the leaf node has been singulated or that the process is within a threshold value of being singulated, control passes to a block 945.

In the block 940, the target path is incremented. A next segment of the target path is selected to provide a new path segment. Control of the process 900 then passes back to the block 910 and the process 900 iterates. For example, the interrogation unit 115 transmits a second portion of N many bits of a target path, such as ‘10’, which may again followed by transmission of a carrier (block 920). This second portion causes the RFID tags 115 on that path (e.g., “1010 . . . ”) to backscatter a second group of N many bits, in this case ‘10’, corresponding to traversal from the node 217 to the node 220.

In the block 945, singulation is completed and verified. The process 900 then ends. The RFID tag 115 and the interrogation unit 110 then can exchange information.

The block 945 includes multiple embodiments corresponding to different scenarios. The interrogation unit 110 may or may not have knowledge of the length of the ID code. Additionally, where the interrogation unit 110 does not have a priori knowledge of the length of the ID codes, several different protocols are possible for achieving singulation.

In one embodiment, when the interrogation unit 110 is provided with knowledge of a length of the ID code a priori, the determination of the query task 935 may be effectuated by the interrogation unit 110 recognizing that all of the bits of the ID code have been received. When the ID code length or entry node selection results in fewer than N bits spanning from the last node polled to the leaf node, the RFID tag 115 corresponding to the singulated leaf node appends dummy characters to the bits spanning from the last node polled to the leaf node and transmits that information back to the interrogation unit 110. The interrogation unit 110 then discards the dummy bits.

FIG. 10 is a flowchart illustrating an interrogation unit 110 process 1000 for singulation and verification of a leaf node when the interrogation unit 110 does not have knowledge of ID code length.

The process 1000 assumes that the RFID tag 115 being singulated will append dummy bits to the last valid bit of the ID code when the RFID tag 115 transmits target path bits back to the interrogation unit. The process 1000 begins in a block 1005.

In the block 1005, the interrogation unit 110 transmits an additional target path segment (e.g., as in block 920). However, because the last target path segment included at least one valid target path bit and at least one invalid target path bit, no response signal is generated from any of the RFID tags 115.

In a block 1010, the interrogation unit 110 waits a predetermined interval and determines that no response signal is received during the predetermined interval.

In a block 1015, the interrogation unit 110 transmits a command, which may be a single bit command, requesting knowledge of a number of significant bits in the last RFID tag 115 response signal.

In a block 1020, the interrogation unit 110 receives a signal from the singulated RFID tag 115 to indicate the number of valid bits in the last RFID tag 115 response signal. For example, when the last target path segment included two bits, only one of which was valid, the singulated RFID tag 115 may transmit a signal at the subcarrier F₁ to indicate that only one of the bits was valid. The process 1000 then ends.

FIG. 11 is a flowchart illustrating an RFID tag 115 process 1100 for singulation and verification of a leaf node when the interrogation unit 110 does not have knowledge of ID code length. The RFID tag 115 process 1100 is a companion process to the interrogation unit process 1000 of FIG. 10.

The process 1100 begins in a block 1105, wherein the RFID tag 115 being singulated recognizes that the last path segment includes one or more invalid path elements, i.e., includes more bits than needed to singulate the leaf node associated with the RFID tag 115.

In a block 1110, the RFID tag 115 being singulated appends one or more dummy bits to a valid portion of the last path segment to form an N-bit long segment, where N is the number of nodes intended to be traversed by the target path segment of block 1105.

In a block 1115, the RFID tag 115 being singulated transmits the N-bit long segment.

In a block 1120, the RFID tag 115 being singulated receives a command requesting a number of valid bits in the N-bit long segment.

In a block 1125, the RFID tag 115 being singulated transmits a symbol indicative of the number of valid bits in the N-bit long segment. The process 1100 then ends.

FIG. 12 is a flowchart illustrating an interrogation unit 110 process 1200 for singulation and verification of a leaf node when the interrogation unit 110 does not have knowledge of ID code length. The process 1200 assumes that the RFID tag 115 recognizes when the leaf node is within N many bits of the present node, where N is the number of bits being traversed in each target path segment, and that the RFID tag 115 does not transmit a reply signal when the leaf node is within N many bits of the present node. The process 1200 begins in a block 1205.

In the block 1205, the interrogation unit 110 transmits data intended to correspond to a target path segment.

In the block 1210, the interrogation unit 110 waits for a predetermined interval for a reply signal.

In a query task 1215, the interrogation unit 110 determines whether a reply was received during the predetermined interval. When the query task 1215 determines that no reply was received during the predetermined interval, control passes to a block 1220.

In the block 1220, the interrogation unit 110 modifies the node level. In one embodiment, the interrogation unit 110 “backs up” one or more nodes. In one embodiment, the interrogation unit 110 may use a binary or other search technique to modify or adjust the node level. Control then passes back to the block 1205 and the process 1200 iterates.

When the query task 1215 determines that a reply was received during the predetermined interval, the RFID tag 115 has been singulated. The process 1210 then ends.

FIG. 13 is a flowchart illustrating an RFID tag 115 process 1300 for singulation and verification of a leaf node when the interrogation unit 110 does not have knowledge of ID code length. The RFID tag 115 process 1300 is a companion process to the interrogation unit process 1200 of FIG. 12.

The process 1300 begins in a block 1305. In the block 1305, the RFID tags 115 determine that the traversal process has proceeded to within N bits of a leaf node.

In a block 1310, the RFID tag 115 waits until a target path segment is received that corresponds to (e.g., ends with) the last N bits in the identification code for that RFID tag 115. In a block 1315, the RFID tag 115 then transmits an acknowledgement signal. The process 1300 then ends.

FIG. 14 is a flowchart illustrating an interrogation unit 110 process 1400 for singulation and verification of a leaf node when the interrogation unit 110 does not have knowledge of ID code length. The process 1400 begins in a block 1405.

In the block 1405, the interrogation unit 110 transmits N bits representing an intended target path segment.

In a block 1410, the interrogation unit 110 waits a predetermined interval following transmission of the intended target path segment.

In a query task 1415, the interrogation unit 110 determines when a response has been received during the predetermined interval. When the query task 1415 determines that no response was received during the predetermined interval, the interrogation unit 110 knows that it is within N-1 node levels of a leaf node, and control passes to a block 1420. When the query task 1415 determines that a response was received during the predetermined interval, control passes to a block 1417. In the block 1417, the target path is incremented and control passes back to block 1405, such that the process 1400 continues singulation.

In the block 1420, the interrogation unit 110 receives a signal from the RFID tags associated with the last target node. These signals use fewer of the subcarrier frequencies, for example, F₀ or F₁ only.

In a block 1425, the interrogation unit transmits a modified or incremental target path segment, such as a single node step command to cause the RFID tags 115 to step to a next lower node level.

In a block 1430, the interrogation unit 110 receives response signals generated by the RFID tags 115 below the next lower node level.

In a query task 1435, the interrogation unit determines when a leaf node has been singulated. When the query task 1435 determines that a leaf node has not yet been singulated, control passes back to the block 1425. When the query task 1435 determines that a leaf node has been singulated, the process 1400 ends.

FIG. 15 is a flowchart illustrating an RFID tag 115 process 1500 for singulation and verification of a leaf node when the interrogation unit 110 does not have knowledge of ID code length. The RFID tag 115 process 1500 is a companion process to the interrogation unit process 1400 of FIG. 14. The process 1500 begins in a block 1505.

In the block 1505, the one or more RFID tags 115 associated with the current node recognize that less than N many bits or node levels separate the current target node from a leaf node.

In a block 1510, the one or more RFID tags 115 wait for a predetermined interval.

In a block 1515, the one or more RFID tags 115 below the last target node transmit signals using a group of fewer of the subcarrier frequencies, for example, F₀ or F₁ only.

In a block 1520, the one or more RFID tags 115 receive a modified target path segment, such as a single node step command to cause the one or more RFID tags 115 to step to a next lower node level.

In a block 1525, the RFID tags 115 that are associated with the next lower node level transmit response signals using the group of fewer subfrequencies.

In a query task 1530, the RFID tags 115 determine when a leaf node has been singulated. When the query task 1530 determines that a leaf node has not been singulated, control passes back to the block 1520. When the query task 1530 determines that a leaf node has been singulated, the process 1500 ends.

It will be appreciated that, while the discussion above has been presented in terms of single bit-length N-FSK symbols being transmitted from the RFID tags 115 to the interrogation unit 110, multiple bit-length N-FSK symbols could be transmitted to encode larger amounts of information.

These arrangements also guarantee no bit or path level collisions. For the example above, there are a maximum of four possibilities for leaf node demographics below node level N-2, using the four subcarrier frequency model discussed above. When all four subcarrier frequencies are detected, the interrogation unit 110 knows that all four leaf nodes are populated. The interrogation unit 110 similarly is provided with information as to which leaf nodes are populated when fewer than four subcarriers are detected and thus avoids selection of node addresses that correspond to unpopulated nodes. This example shows that using four subcarriers allows the interrogation unit 110 to determine tree population from a branch node at the N-2 node level with a single transmission 125 and response 135, in contrast to multiple signal exchanges needed by conventional signaling protocols for such a determination. When an odd number of bits represent the path from the root to the leaf nodes 240, the RFID tag 115 may append a “0” to the last bit to determine which subcarrier to employ for the symbol.

It will be appreciated that other arrangements using more subcarriers can provide greater efficiency in communicating signals by the reverse link. When 2^{N} subcarriers are employed on the reverse link, 2^{N} N-bit paths emanating from a given node may be mapped to them and N many nodes can be traversed with each interrogation unit 110 command. The RFID tags 115 are able to transmit N bits per interrogation unit command, in comparison to the slower data rates possible with conventional RFID tag systems.

By including multiple bits in each symbol, the interrogation unit 110 is able to traverse multiple nodes in a single command. This results in increased throughput and also guarantees absence of bit level collisions and path level collisions. The number of subcarriers need not be a multiple of two; any integer number of subcarriers may be employed.

FIG. 16 is a block diagram representing a portion 1600 of a signal exchange between one or more RFID tags 115 and an interrogation unit 110. The portion 1600 begins with a bit-by-bit exchange of signals whereby single symbol interrogation unit or reader signals S_{R} 1605 are interleaved with single symbol RFID tag signals S_{T} 1610. This format for data exchange is conventional for transmission of data bits or symbols from RFID tags 115 and results in a symbol period T_{S1} having a duration equal to a time for the interrogation unit 110 signal S_{R} 1605 plus a time for the RFID tag 115 signal S_{T} 1610. The interrogation unit 110 symbols S_{R} 1605 and the RFID tag 115 symbols S_{T} 1610 may represent single bits, or these symbols S_{R} 1605 and/or S_{T} 1610 may represent more than one bit of information. In some communication protocols and under some conditions, such as when a singulated RFID tag 115 is transmitting data back to the interrogation unit 110, the interrogation unit 110 symbols S_{R} 1605 may represent “dummy” bits, however, dummy bits add to the duration of each symbol exchange period.

A burst command 1615 may be transmitted from the interrogation unit 110 to the RFID tags 115. Alternatively, under predetermined conditions, the interrogation unit 110 and/or the RFID tags 115 may switch to a burst mode.

For purposes of this document, a burst is a sequential transmission of at least two symbols along one of the forward and reverse links, without an intervening transmission between the two symbols along the other one of the forward and reverse links. One symbol is sometimes transmitted with two codes (sometimes called “chips”, e.g., two bits, a low or ZERO and a high or ONE), and the symbol is the transition from the low to the high.

In the burst mode, a series of single RFID tag 115 symbols S_{T} 1620 are transmitted from one or more RFID tags 115. The burst mode results in a symbol period T_{S2} having a duration equal to a time for the RFID tag 115 signal S_{T} 1620 alone. As a result, data exchange from the RFID tag(s) 115 to the interrogation unit 110 is more rapid for any given symbol length.

FIG. 17 is a flowchart describing a singulation process 1700. The singulation process 1700 begins in a block 1705.

In the block 1705, an individual RFID tag 115 is singulated. The RFID tag 115 may be singulated using techniques described hereinabove or via conventional techniques.

In one embodiment, the RFID tag 115 is singulated using a proxy identification code having a length that is much less than a length of a full identification code for that RFID tag 115. For example, the proxy identification code might have a length in a range of from 10 to 20 or 30 bits, while a full identification code may have a length of up to 256 bits or more. In one embodiment, the RFID tag 115 may be singulated using the full identification code.

In a block 1710, communications switch to a burst mode. In one embodiment, the singulated RFID tag 115 switches to a burst mode of communication.

In a block 1715, data are exchanged in the burst mode. In one embodiment, the singulated RFID tag 115 transmits data to the interrogation unit 110 in the block 1715. In the embodiment where the RFID tag 115 was singulated using the proxy identification code, the RFID tag 115 may transmit a full identification code in the burst mode. The RFID tag 115 may transmit other data to the interrogation unit 110 as well. When data communication ends, control passes to a query task 1720.

In the query task 1720, the process 1700 determines when further RFID tag 115 singulation is needed. When the query task 1720 determines that no further RFID tag 115 singulation is needed, the process 1700 ends.

When the query task 1720 determines that further RFID tag 115 singulation is needed, another target RFID tag 115 is selected in a block 1725. Control then passes back to the block 1705. The process 1700 then iterates.

FIG. 18 is a flowchart of a process 1800 describing a map mode for determination of collision-free portions of identification code sequences for a population of RFID tags 115. The process 1800 begins in a block 1805.

In the block 1805, the interrogation unit 110 sends a global command to cause all of the RFID tags 115 in the population 105 to transmit their identification codes contemporaneously, that is, in relatively close synchrony. In one embodiment, the command causes the RFID tags 115 to transmit the identification codes in a burst mode, which may include the entire identification code or a portion of the identification code. In one embodiment employing backscatter for the reverse link, the interrogation unit 110 then transmits a carrier.

In a block 1810, the interrogation unit 110 monitors the identification codes transmitted back from the RFID tags 115 for portions having collisions. In one embodiment, the interrogation unit 110 is able to determine which portions of the identification codes involve collisions by determining when energy has been transmitted at more than one of the N many frequencies described above.

In a block 1815, the interrogation unit 110 determines collision-free portions of the identification codes. This requires that the RFID tags 115 transmit such that at least a portion of each bit position from each of the RFID tags 115 overlap the same bit position in the sequence from the other RFID tags 115. In one embodiment, the interrogation unit 110 detects absence of collisions by determining those bit positions where received energy is present at only one of the receivers RX₁ 160 through RX_{N} 190 of FIG. 1 during a particular bit interval.

In a block 1820, the interrogation unit 110 sets one or more block lengths based on the collision-free portions of the identification codes. In one embodiment, the interrogation unit 115 determines lengths of collision-free blocks within the identification codes, that is, determines a length for each collision-free block.

In one embodiment, the block 1820 determines a block length consistent with several collision-free blocks. For example, when collision-free blocks having lengths of 10 bits, 12 bits and 20 bits are identified, a block length of 10 or fewer bits is consistent with each of the identified collision-free block lengths. Traversal then may be implemented by switching to the burst mode at corresponding points in the identification code, for example, by transmitting commands to switch to or from the burst mode. If an additional collision-free block of three bits in length was also identified, it may still be desirable to select a block length, such as five to ten bits, that is less than or equal to the first three block lengths but that is not consistent with the shorter collision-free block length.

In a block 1825, the block length information is exchanged between the interrogation unit 110 and the RFID tags 115. The process 1800 then ends.

FIG. 19 is a flowchart of a singulation process 1900 employing burst mode communications. The process 1900 begins in a block 1905.

In the block 1905, an entry node is selected. In one embodiment, the entry node is chosen to be a most significant bit or a least significant bit of the identification code. In one embodiment, the entry node is selected using a priori knowledge of population demographics for the RFID tags 115. In one embodiment, the entry node may be selected using principles described above.

In a block 1910, a command sets the RFID tag(s) 115 to a burst mode. For example, when a single bit traversal process is operative and it is determined that a predetermined number of bits have been traversed without a collision being observed, it is possible that a particular RFID tag 115 has been singulated.

While a full identification code may be very long (e.g., 256 bits), when 20 bits have been traversed, more than one million different codes have also been traversed. Similarly, 30 bits correspond to more than a billion different codes. Thus, a population 105 of RFID tags 115 having fewer than one million RFID tags in it can be provided with unique identification codes for each member of the population 105 where only the first or last (or any other grouping or groupings) of bits totaling twenty (or fewer) bits differ.

In a block 1915, the RFID tag or tags 115 that are in the traverse state transmit a burst of M many symbols back to the interrogation unit 110.

In a query task 1920, the process 1900 determines if a collision between transmissions from two or more RFID tags 115 has occurred. When the query task 1920 determines that a collision has occurred, control passes to a block 1925.

In the block 1925, a null command returns the RFID tags 115 that are in the traverse state to a transactional mode or a single symbol mode of communication. The RFID tags 115 that are in the traverse state also return to the beginning of the data block in which the collision occurred, i.e., the most recent block of bits. The process 1900 then ends and singulation proceeds according to any of the protocols described herein or any conventional protocol.

When the query task 1920 determines that a collision has not occurred during the most recent burst transmission, control passes to a block 1930. In the block 1930, the interrogation unit 110 acknowledges the most recent block of data. For example, the interrogation unit 110 may echo the last bit or symbol from the block, or may transmit any other predetermined acknowledgement signal.

In a block 1935, a next group of bits are selected. Control then passes back to the block 1915 to transmit the selected group of bits.

FIG. 20 is a flowchart of a singulation process 2000 employing burst mode communications. The process 2000 begins in a block 2005.

In the block 2005, the process 2000 traverses a portion of the population 105. The portion may be traversed one node per transaction or may be traversed more than one node per transaction.

In a query task 2010, the process 2000 determines when no collisions have taken place for a predetermined number K of nodes. When the query task determines that the predetermined number K of collision-free nodes have not been traversed, control passes back to block 2005. When the query task determines that the predetermined number K of collision-free nodes have been traversed, control passes to a block 2015.

In the block 2015, the process 2000 switches to a burst mode. For example, the interrogation unit 110 may transmit a command to cause the portion of the population 105 that is in the traverse mode to switch to a burst mode.

In a block 2020, the interrogation unit 110 and the traversing portion of the population 105 exchange a block of data comprising a predetermined number of symbols.

In a query task 2025, the process 2000 determines when the block of data included any collisions. When the query task 2025 determines that the data block was received with collisions, control passes to a block 2030.

In the block 2030, the process 2000 returns to the transactional mode. For example, a null command returns the RFID tags 115 that are in the traverse state to a transactional mode or a single symbol mode of communication. The RFID tags 115 that are in the traverse state also return to the beginning of the data block in which the collision occurred, i.e., the most recent block of bits. The process 2000 then ends and singulation proceeds according to any of the protocols described herein or any conventional protocol.

When the query task 2025 determines that the block of data was exchanged without any collisions, control passes to a block 2035. In the block 2035, the interrogation unit 110 acknowledges the most recent block of data. For example, the interrogation unit 110 may echo the last bit or symbol from the block, or may transmit any other predetermined acknowledgement signal.

In a block 2040, a next group of bits are selected. Control then passes back to the block 2020 to traverse the selected group of bits.

Computer Storage Media

The memory 155 of FIG. 1 and the memory 845 of FIG. 8 each store program modules corresponding to one or more of the processes of FIGS. 3-5 and 10-15. In one embodiment, the memory 155 and/or the memory 845 comprise non volatile semiconductor memories, which may include a write capability. Other forms of computer readable media may also be optionally interfaced with either the interrogation unit 110 or the RFID tags 115.

By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer storage media includes, but is not limited to, RAM, ROM, EEPROM, flash memory or other memory technology, CD, digital versatile disks (DVD) or other optical storage, magnetic cassettes, magnetic tape, magnetic disk storage or other magnetic storage devices, or any other media which can be used to store the desired information and which can be accessed by control logic.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as wired network or direct-wired connection, and wireless media such as acoustic, RF, infrared and other wireless media. Combinations of any of the above should also be included within the scope of computer readable media.

The present disclosure is provided in part in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

For purposes of illustration, programs and other executable program components such as the operating system are illustrated herein as discrete blocks, although it is recognized that such programs and components reside at various times in different storage components, and are executable by a processor, CPU or control logic. Alternatively, the concepts disclosed herein may be implemented in hardware or a combination of hardware, software, and/or firmware. For example, one or more application specific integrated circuits (ASICs) could be designed or programmed to embody the concepts disclosed herein.

Additionally, it will be appreciated that the interrogation unit 110 and the RFID tags 115 may include capabilities for operating in more than one of the modes described herein, and may include capability for switching to a specific one of these modes. Further, it will be appreciated that either the interrogation unit 110 or the RFID tags 115 may include a capability for being programmed with additional modes of operation or with newer versions of one of the modes of operation.

### EXAMPLE

FIGS. 21 and 22 are timing charts providing examples of signal exchanges, such as between an interrogation unit 110 (FIG. 1) and one or more RFID tags 115 within a population of tags 105. FIGS. 21 and 22 each show a graph of signal amplitude (ordinate) versus time (abscissa), with both abscissa and ordinate corresponding to arbitrary units. FIG. 21 depicts series of interrogation/command signals, represented by S₁, S₂, S₃, are shown as being interleaved with a corresponding series of response signals R₁, R₂, R₃, with a duration of a time T₁ from a beginning of signal S₁ to a termination of signal R₃. FIG. 22 depicts serial transmission of a group of symbols SN followed by a response signal R_{1-N} with a duration of a time T₂ that is less than the duration T₁, from a beginning of signal S₁ to a termination of signal R_{1, 2, 3}, where the signal R_{1, 2, 3} represents, e.g., three bits. It will be appreciated that more or fewer bits may be conferred by signal via suitable choices of subcarrier frequencies.

In one aspect, FIG. 21 can be used to illustrate a conventional, bit-by-bit, binary tree traversal process. In that aspect, signals SN are transmitted from the interrogation unit and signals RN are returned by one or more of the population of tags. As a result, when the signals are transmitted using a single response signal frequency choice, the time T₁ is needed in order to exchange three bits of information between the interrogation unit and the tag population.

However, when the signals R_{N} each may comprise different spectral content with the spectral content also corresponding to two or more bits, the scenario shown in FIG. 21 provides advantages in efficiency because more information may be exchanged within the interval T₂ than was possible in the prior art. In other words, the concepts of the present disclosure facilitate completion of traversal of a binary tree in less time that was needed according to the prior art.

### CONCLUSION

The concepts described herein provide significant advantages compared to prior art RFID tag systems. The protocols described herein do not require the interrogation intervals ordinarily associated therewith. As a result, these protocols and systems require fewer interrogation operations to sequentially singulate a tag population.

Although the disclosed concepts have been described in language specific to structural features and/or methodological acts, it is to be understood that the subject matter defined in the appended claims is not necessarily limited to the specific features or acts described. Rather, the specific features and acts are disclosed as exemplary forms of implementing the claimed subject matter.

1. An apparatus for exchanging data between one or more RFID tags and an interrogation unit comprising means for transmitting a burst of data from the one or more RFID tags.

2. The apparatus of claim 1 wherein the transmitting means is operative responsive to a burst mode command from the interrogation unit.

3. The apparatus of claim 1 wherein the transmitting means is configured to be operative following an exchange of signals between the interrogation unit and the one or more RFID tags, the signals each representing a single bit.

4. The process of claim 1 wherein the transmitting means is configured to be operative following an exchange of signals between the interrogation unit and the one or more RFID tags in a transactional mode.

5. The apparatus of claim 1 wherein the transmitting means is configured to be operative following an exchange of signals between the interrogation unit and the one or more RFID tags, the signals each representing a single symbol.

6. The apparatus of claim 1 wherein the means for transmitting a burst of data is configured to be operative after singulating.

7. The apparatus of claim 1 wherein the transmitting means employs more than two different subcarrier frequencies.

8. The apparatus of claim 1 wherein the transmitting means includes capability for transmitting appended dummy codes when a length of the burst exceeds a length of data to be transmitted.

9. The apparatus of claim 1 wherein the transmitting means includes capability for transmitting a full identification code of an RFID tag in a burst.

10. The apparatus of claim 1 wherein the transmitting means includes capability for transmitting a full identification code of a singulated RFID tag.

11. A process for sending data via a reverse link from one or more RFID tags comprising switching between a burst mode and a transactional mode.

12. The process of claim 11, further comprising switching to the transactional mode in response to a null command.

13. The process of claim 11, further comprising switching, in one or more of the RFID tags, to the transactional mode in response to receiving a null command.

14. The process of claim 11, further comprising switching, in one or more of the RFID tags, to the burst mode in response to receiving to a burst command.

15. The process of claim 11, further comprising receiving, in the RFID tags, a null command responsive observation of a collision of signals from two or more RFID tags.

16. The process of claim 11, wherein switching to the burst mode is performed in response to a command determining burst length.

17. The process of claim 11, wherein switching to the burst mode comprises switching to the burst mode and to a predetermined burst length.

18. The process of claim 11, wherein switching to the burst mode follows singulation using a proxy identification code in the transactional mode.

19. The process of claim 11, further comprising:
singulating an RFID tag using a proxy identification code in the transactional mode;
switching to the burst mode; and
receiving a full identification code from the singulated RFID tag in the burst mode.

20. A radio frequency identification (RFID) tag configured to transmit signals in a burst mode or a transactional mode.

21. The RFID tag of claim 20, wherein the RFID tag is configured to switch from the transactional mode to the burst mode in response to a command.

22. The RFID tag of claim 20, wherein the RFID tag is configured to switch to the burst mode in response to a command, wherein a burst length is set by another command.

23. The RFID tag of claim 20, wherein the RFID tag is configured to switch to the transactional mode in response to a command.

24. The RFID tag of claim 20, wherein the RFID tag is configured to:
switch to the transactional mode in response to a command; and
negotiate a bit sequence corresponding to an immediately previous burst in the transactional mode.

25. The RFID tag of claim 20, wherein the RFID tag is configured to traverse a binary tree in the transactional mode, and, following singulation, switch to the burst mode.

26. The RFID tag of claim 20, wherein the RFID tag is configured to accept a burst length, transmit a first burst of data, repeatedly transmit sequential bursts of data when confirmation of a previous burst is received and switch to the transactional mode when a null command is received.

27. The RFID tag of claim 20, wherein the RFID tag is configured to be singulated in the transactional mode and then switch to the burst mode.

28. The RFID tag of claim 20, wherein the RFID tag is configured to switch between burst mode and transactional mode during singulation.

29. The RFID tag of claim 20, wherein the RFID tag is configured to transmit using an n-ary frequency shift keying mode, where n exceeds two.

30. A process for communicating with one or more RFID tags, comprising:
determining portions of a binary sequence corresponding to identification codes that are collision-free for a population of RFID tags;
developing one or more burst lengths in response to determining; and
transmitting a command to set the one or more burst lengths for the population.

31. The process of claim 30, wherein determining comprises:
transmitting a global command to transmit identification codes to the population; and
monitoring for data collisions in the transmitted identification codes.

32. The process of claim 30, further comprising traversing the population by using a burst mode for at least some collision-free portions of a binary identification sequence and a transactional mode for other portions of the binary identification sequence.

33. The process of claim 30, further comprising traversing the population by using a burst mode for at least some collision-free portions of a binary identification sequence and a transactional mode for at least some other portions of the binary identification sequence; and
receiving data from a singulated RFID tag of the population using the burst mode.

34. The process of claim 30, further comprising:
receiving a burst of data from one or more RFID tags of the population;
analyzing the burst to determine if the burst is collision-free;
when the burst is collision-free, acknowledging the burst; and
otherwise transmitting a null command.

35. The process of claim 30, further comprising:
receiving a burst of data from one or more RFID tags of the population, the burst comprising a signal having one of a plurality of more than two possible subfrequencies;
analyzing the burst to determine if the burst is collision-free; and
when the burst is collision-free, acknowledging the burst and otherwise transmitting a null command.

36. An apparatus for communicating with one or more RFID tags, comprising:
means for receiving a burst of data from one or more RFID tags; and
means for transmitting a null command when the burst is not collision-free.

37. The apparatus of claim 36 wherein the means for transmitting a null command comprises means for switching from a burst mode to a transactional mode.

38. The apparatus of claim 36, further comprising means for transmitting an acknowledgement when the burst is collision-free.

39. The apparatus of claim 36, further comprising:
means for transmitting an acknowledgement when the burst is collision-free; and
means for receiving a subsequent data burst.

40. The apparatus of claim 36 wherein the receiving means comprises means for receiving a signal having one of a plurality of more than two possible subfrequencies.

41. An apparatus for exchanging data with one or more RFID tags and by exchanging a burst of data between the apparatus and the one or more RFID tags.

42. The apparatus of claim 41 wherein one or more of the RFID tags transmits the burst at one data rate following an exchange of signals, at a second data rate lower than the first data rate, between the interrogation unit and the one or more RFID tags, the signals each comprising a single bit.

43. The apparatus of claim 41 wherein one or more of the RFID tags transmits the burst in response to a burst mode command from the interrogation unit.

44. The apparatus of claim 41 wherein one or more of the RFID tags transmits the burst at one data rate following an exchange of signals, at a second data rate lower than the first data rate, between the interrogation unit and the one or more RFID tags, the signals each comprising a single bit.

45. The apparatus of claim 41 wherein one or more of the RFID tags transmits the burst following an exchange of signals between the interrogation unit and the one or more RFID tags in a transactional mode.

46. The apparatus of claim 41 wherein one or more of the RFID tags transmits the burst following an exchange of signals between the interrogation unit and the one or more RFID tags, the signals each comprising a single symbol.

47. The apparatus of claim 41 wherein one or more of the RFID tags transmits the burst following singulation of an RFID tag.

48. The apparatus of claim 41 wherein one or more of the RFID tags transmits the burst following singulation of an RFID tag using a full identification code.

49. The apparatus of claim 41 wherein one or more of the RFID tags transmits the burst following singulation of an RFID tag using a pseudo identification code.

50. The apparatus of claim 41 wherein one or more of the RFID tags transmits the burst and the burst includes the full identification code of an RFID tag.

51. The apparatus of claim 41 wherein one or more of the RFID tags transmits the burst and the burst includes the full identification code of a singulated RFID tag.

52. The apparatus of claim 41 wherein one or more of the RFID tags transmits the burst and the data burst has a length of M many bits and wherein M is determinable by a command from the interrogation unit.

53. The apparatus of claim 41 wherein, following the transmitting the burst, the one or more RFID tags receive a command to switch to a binary tree traversal mode.

54. The apparatus of claim 41 wherein, following the transmitting the burst, the one or more RFID tags receive a command to switch to a transactional binary tree traversal mode.

55. The apparatus of claim 41 wherein one or more of the RFID tags transmits the burst in response to a global command from the interrogation unit to provide an identification code.

56. The apparatus of claim 41 wherein one or more of the RFID tags transmits the burst in response to a burst mode command from the interrogation unit.
